(19) United States
(12) Patent Application Publication
(10) Pub. No.: US 2025/0173667 A1
(43) Pub. Date: May 29, 2025

(54) SYSTEMS, APPARATUSES, AND METHODS FOR ENHANCING DELIVERY OF ENERGY MATERIALS FROM ENERGY MATERIAL PRODUCTION FACILITIES TO DELIVERY DESTINATIONS

(71) Applicant: MARATHON PETROLEUM COMPANY LP, Findlay, OH (US)

(72) Inventors: Abby E. Trombley, Findlay, OH (US); Krishnan Krishnaiyer, Findlay, OH (US)

(21) Appl. No.: 18/891,623

(22) Filed: Sep. 20, 2024

Related U.S. Application Data
(60) Provisional application No. 63/603,457, filed on Nov. 28, 2023.

(51) Int. Cl. G06Q 10/0835

(52) U.S. Cl. CPC G06Q 10/08355

(57) ABSTRACT

Systems, apparatuses, and methods for enhancing delivery of energy materials from energy material production facilities to delivery destinations via vehicles, may include obtaining energy material production data associated with the energy material production facilities and vehicle data for the vehicles. An analytical route model maybe used to determine a tailored transportation route for the vehicles. Travel according to the tailored transportation route may be simulated via an analytical event simulation model. Adjusted tailored transportation routes and adjusted energy material production may be determined based at least in part on the travel simulation results. A logistical transportation schedule for the vehicles may be determined, based at least in part on the adjusted tailored transportation routes and the adjusted energy material production, thereby to enhance the delivery of the energy materials from the energy material production facilities, via the vehicles, to the delivery destinations.

### CROSS REFERENCE TO RELATED APPLICATIONS

This application claims priority to, and the benefit of U.S. Provisional Application No. 63/603,457, filed Nov. 28, 2023, titled “SYSTEMS, APPARATUSES, AND METHODS FOR ENHANCING DELIVERY OF ENERGYMATERIALS FROM ENERGY MATERIAL PRODUCTION FACILITIES TO DELIVERY DESTINATIONS,” the disclosure of which is incorporated herein by reference in its entirety.

### TECHNICAL FIELD

The present disclosure relates to systems, apparatuses, and methods for enhancing delivery of energy materials from energy material production facilities to delivery destinations and, more particularly, to systems, apparatuses, and methods for enhancing delivery of energy materials from energy material production facilities to delivery destinations via vehicles.

### BACKGROUND

Energy materials are transported from energy material production facilities to numerous delivery destinations at a variety of geographic locations. For example, vehicles may be used to transport energy materials, such as fuels and hydrocarbon products, from a location at which the fuel and hydrocarbon products are produced to various delivery destinations, such as intermediate locations and final destinations, resulting in numerous vehicles traveling between numerous locations to receive, transport, and deliver fuel and hydrocarbon materials. In this manner, vehicles facilitate the efficient and effective transport of large quantities of energy materials. The length of time required for transporting such materials may vary greatly, depending on, for example, the availability of the materials at production facilities, the routes traveled by the vehicles, and various events that may slow travel of the vehicles.

A scheduler may typically create a schedule for delivery of materials to delivery destinations. For example, as scheduler may consider product availability and vehicle availability, and select transportation vehicles for making the respective deliveries. Scheduling in this manner may often result in inefficiencies associated with the deliveries due, for example, to the complex nature of selecting from among numerous vehicles, numerous manufacturing facilities, and numerous transportation routes. In addition, it may be difficult for a scheduler to account for both predictable and unpredictable delays associated with transporting the materials to the numerous delivery destinations. Accounting for the numerous possible combinations of products to deliver, vehicles for transporting the products, and the routes to the delivery destinations may not be possible for a scheduler due to the seemingly infinite number of possible combinations. The most efficient and/or effective scheduling combinations may not be selected. As a result, scheduling inefficiencies may be common, and/or deliveries may fail to meet expectations.

Accordingly, Applicant has recognized a desire to manage shipment of materials in a more efficient and/or more effective manner, thereby to enhance transportation and delivery of materials from production facilities to delivery destinations. The present disclosure may address one or more of the above-referenced considerations, as well as other possible considerations.

### SUMMARY

As referenced above, Applicant has recognized that it may be desirable to provide systems, apparatuses, and methods to manage shipment of materials in a more efficient and/or more effective manner, thereby to enhance delivery of materials from production facilities to delivery destinations. Applicant has recognized that coordinating and/or creating logistics schedules for transporting materials of various types may account for numerous combinations of manufacturing facilities, vehicles, routes of travel, and/or transport delays. Applicant has also recognized that it may be desirable to account and adjust for real-time changes, for example, such as changes in demand, production delays, inclement weather, and/or changes in availability of loading/unloading facilities, among other factors affecting transportation of materials between production facilities and delivery destinations.

In some embodiments, the present disclosure is generally directed to embodiments of systems, apparatuses, and methods for communicating, tracking, and/or controlling logistical data between production facilities, storage facilities, vehicles, and delivery destinations. Such systems, apparatuses, and methods may determine a logistical transportation schedule via a transportation route engine or circuitry. The transportation route engine or circuitry may include one or more analytical models, such as a mathematical model or machine learning model or classifier. Such a logistical transportation schedule may include identification of one or more vehicles to receive energy materials from one or more energy material production facilities for transportation to one or more delivery destinations, for example, according to a schedule at a specified time and/or according to a tailored transportation route. The logistical transportation schedule may be determined based on a number of inputs received by the transportation route engine or circuitry. In some embodiments, the inputs may include, for example, (a) the status and/or characteristics of the vehicles (e.g., availability, capacity, type, range, and/or speed, among other characteristics), (b) energy material production facilities and/or storage facilities (e.g., locations of the energy materials), (c) the delivery destinations, (d) the demand associated with the delivery destinations, (e) the time the energy materials are due to be delivered to the delivery destinations, (f) conditions associated with the transportation route, and/or (g) other factors that may affect transportation of the energy materials to the delivery destinations. In some embodiments, the transportation route engine or circuitry (e.g., the analytical model) may determine or generate the logistical transportation schedule. The logistical transportation schedule may result in relatively more efficient and/or more effective transportation of the energy materials to the delivery destinations, may consume relatively fewer transportation resources, may utilize relatively fewer computing resources than other scheduling procedures, and/or may result in reduced transportation time for delivering the energy materials to the delivery destinations.

In some embodiments, once the logistical transportation schedule is determined or generated, the logistical transportation schedule may be simulated with one or more events via an event simulation model, engine, or circuitry. The events may be discrete and/or may include potential scenarios, situations, or circumstances that may occur where the logistical transportation schedule is to be implemented. In some embodiments, after the logistical transportation schedule is simulated, the event simulation model, engine, or circuitry may output simulation results including the logistical transportation schedule, an adjusted logistical transportation schedule, a comparison between the logistical transportation schedule and the adjusted logistical transportation schedule, statuses and states of the events simulated, and/or the results of one or more such simulations.

In some embodiments, upon completion of the simulation and output of the simulation results, the systems, apparatuses, and methods may generate a visualization. In such embodiments, the systems, apparatuses, and methods may include a graphical user interface (GUI). The GUI may enable a user to execute the analytical model of the transportation route engine or circuitry and execute the event simulation model, engine, or circuitry. The GUI may include a display device that may include a window or screen that displays results of the event simulation model. In some embodiments, the GUI may include an ability to illustrate the route of the logistical transportation schedule on a map depicting related geographic regions. The GUI may depict various utilization statuses, states, bottlenecks, and/or other occurrences relative to the route. The GUI further may include an input device to facilitate input by a user of a logistical transportation schedule and simulate the logistical transportation schedule. The GUI may display the visualization based on the output of the analytical model and/or the event simulation model output.

In some embodiments, the systems, apparatuses, and methods may further provide an option to initiate the logistical transportation schedule. The route determination engine or circuitry may include a machine learning model. The machine learning model may be trained with a one or more logistical transportation schedules having known outcomes. As new logistical transportation schedules are generated and simulated, the new logistical transportation schedules and the corresponding actual outcomes of the implementations, or initiations of the logistical transportation schedules, may be communicated to the machine learning model to further tune, refine, and/or train the machine learning model.

According to some embodiments, a method for enhancing delivery of energy materials from one or more energy material production facilities, via a plurality of vehicles, to one or more delivery destinations, may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The method further may include determining, via an analytical route model, a tailored transportation route for at least some of the plurality of vehicles based at least in part on: (a) the energy material production data, (b) the available energy material data, and (c) the vehicle data. The method also may include simulating, via an analytical event simulation model, travel according to the tailored transportation route for each of the at least some of the plurality of vehicles, thereby to generate travel simulation results. The method also may include determining an adjusted tailored transportation route based at least in part on the travel simulation results. The adjusted tailored transportation route may include adjustment of the tailored transportation route for one or more of the at least some of the plurality of vehicles. The method further may include determining a logistical transportation schedule for each of the at least some of the plurality of vehicles, thereby to enhance the delivery of the energy materials from the one or more energy material production facilities, via the plurality of vehicles, to the one or more delivery destinations. The logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

According to some embodiments, a method for enhancing operation of one or more one or more energy material production facilities for producing energy materials, may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The method also may include determining, via an analytical route model, a tailored transportation route for at least some of the plurality of vehicles based at least in part on: (a) the energy material production data, (b) the available energy material data, and (c) the vehicle data. The method further may include simulating, via an analytical event simulation model, travel according to the tailored transportation route for each of the at least some of the plurality of vehicles, thereby to generate travel simulation results. The method also may include determining adjusted energy material production for the one or more energy material production facilities based at least in part on: (a) the travel simulation results, (b) the energy material production data, (c) the available energy material data, and (d) demand for the energy materials, the adjusted energy material production including an amount of energy material to produce by each of the at least some energy material production facilities. The method further may include determining an adjusted tailored transportation route based at least in part on: (a) the travel simulation results and (b) the adjusted energy material production. The adjusted tailored transportation route may include adjustment of the tailored transportation route for one or more of the at least some of the plurality of vehicles. The method also may include determining a logistical transportation schedule for each of the at least some of the plurality of vehicles, thereby to enhance operation of the one or more energy material production facilities. The logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

According to some embodiments, a method for enhancing a logistical transportation schedule for delivery of energy materials from one or more energy material production facilities, via a plurality of vehicles, to one or more delivery destinations, may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The method also may include determining, via an analytical route model, a tailored transportation route for at least some of the plurality of vehicles based at least in part on: (a) the energy material production data, (b) the available energy material data, and (c) the vehicle data. The method further may include determining adjusted energy material production for the one or more energy material production facilities based at least in part on: (a) the energy material production data, (b) the available energy material data, and (c) demand for the energy materials. The adjusted energy material production may include an amount of energy material to produce by each of the at least some energy material production facilities. The method also may include determining an adjusted tailored transportation route based at least in part on: (a) the adjusted energy material production, the adjusted tailored transportation route including adjustment of the tailored transportation route for one or more of the at least some of the plurality of vehicles. The method further may include determining a logistical transportation schedule for each of the at least some of the plurality of vehicles, thereby to enhance the delivery of the energy materials from the one or more energy material production facilities, via the plurality of vehicles, to the one or more delivery destinations. The logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

According to some embodiments, a scheduling system for enhancing generation of a logistical transportation schedule for delivery of energy materials from one or more energy material production facilities, via a plurality of vehicles, to one or more delivery destinations, may include a logistics controller in communication with one or more of: (a) one or more of the plurality of vehicles, (b) one or more of the energy material production facilities, or (c) one or more of the delivery destinations. The logistics controller may be configured to obtain (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The logistics controller further may be configured to obtain vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The logistics controller also may be configured to determine, via an analytical route model, a tailored transportation route for at least some of the plurality of vehicles based at least in part on: (a) the energy material production data, (b) the available energy material data, and (c) the vehicle data. The logistics controller further may be configured to determine adjusted energy material production for the one or more energy material production facilities based at least in part on: (a) the energy material production data, (b) the available energy material data, and (c) demand for the energy materials, the adjusted energy material production including an amount of energy material to produce by each of the at least some energy material production facilities. The logistics controller also may be configured to determine an adjusted tailored transportation route based at least in part on the adjusted energy material production, the adjusted tailored transportation route including adjustment of the tailored transportation route for one or more of the at least some of the plurality of vehicles. The logistics controller further may be configured to determine a logistical transportation schedule for each of the at least some of the plurality of vehicles, thereby to enhance the delivery of the energy materials from the one or more energy material production facilities, via the plurality of vehicles, to the one or more delivery destinations. The logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

According to some embodiments, a vehicle system for enhancing delivery of energy materials from one or more energy material production facilities to one or more delivery destinations, may include a plurality of vehicles for transporting energy materials from one or more energy material production facilities to one or more delivery destinations. The vehicle system further may include a logistics controller in communication with one or more of: (a) one or more of the plurality of vehicles, (b) one or more of the energy material production facilities, or (c) one or more of the delivery destinations. The logistics controller may be configured to obtain (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. the logistics controller further may be configured to obtain vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The logistics controller also may be configured to determine, via an analytical route model, a tailored transportation route for at least some of the plurality of vehicles based at least in part on: (a) the energy material production data, (b) the available energy material data, and (c) the vehicle data. The logistics controller further may be configured to determine adjusted energy material production for the one or more energy material production facilities based at least in part on: (a) the energy material production data, (b) the available energy material data, and (c) demand for the energy materials. The adjusted energy material production may include an amount of energy material to produce by each of the at least some energy material production facilities. The logistics controller also may be configured to determine an adjusted tailored transportation route based at least in part on the adjusted energy material production. The adjusted tailored transportation route may include adjustment of the tailored transportation route for one or more of the at least some of the plurality of vehicles. The logistics controller further may be configured to determine a logistical transportation schedule for each of the at least some of the plurality of vehicles, thereby to enhance the delivery of the energy materials from the one or more energy material production facilities, via the plurality of vehicles, to the one or more delivery destinations. The logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to illustrate embodiments of the disclosure more clearly.

FIG. 1 is a schematic block diagram of an example energy material production and delivery system, including an example vehicle system and an example scheduling system for enhancing generation of a logistical transportation schedule for delivery of energy materials from one or more energy material production facilities, via a plurality of vehicles, to one or more delivery destinations, according to embodiments of the disclosure.

FIG. 2A is a block diagram of example energy material production data, according to embodiments of the disclosure.

FIG. 2B is a block diagram of example available energy material data, according to embodiments of the disclosure.

FIG. 3 is a block diagram of example route tailoring factors, according to embodiments of the disclosure.

FIG. 4 is a block diagram of an example logistical transportation schedule, according to embodiments of the disclosure.

FIG. 5A is a block diagram of example vehicle data, according to embodiments of the disclosure.

FIG. 5B is a block diagram of example further vehicle data, according to embodiments of the disclosure.

FIG. 5C is a block diagram of example further vehicle data, according to embodiments of the disclosure.

FIG. 6 is a block diagram of example terminal data, according to embodiments of the disclosure.

FIG. 7 is a block diagram of example vehicle travel delay data, according to embodiments of the disclosure.

FIG. 8 is a block diagram of example delivery biasing factors, according to embodiments of the disclosure.

FIG. 9 is a schematic block diagram of an example scheduling system for enhancing generation of a logistical transportation schedule for delivery of energy materials from one or more energy material production facilities and/or one or more storage facilities, via one or more vehicles, to one or more delivery destinations, according to embodiments of the disclosure.

FIG. 10 is a simplified block diagram of a scheduling system for determination and/or simulation of a logistical transportation schedule, according to embodiments of the disclosure.

FIG. 11 is a simplified block diagram of a scheduling system for determining and/or simulating a logistical transportation schedule, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

A human scheduler may typically create a logistical schedule. Such schedulers may consider available products, goods, and transportation vehicles, and select different transportation vehicles and routes for delivering the products to appropriate destinations. Such scheduler-based scheduling may be inherently inefficient. Moreover, accounting for numerous (sometimes thousands) of different combinations of factors associated with delivery of products and goods to correct destinations may be extremely difficult (or impossible) for even an experienced scheduler. For example, thousands of possible routes may exist between production facilities and delivery destinations. In addition, certain routes may be subject to numerous delays, adding complexity. In fact, complexities associated with finding efficient or optimal scheduling solutions may be beyond a scheduler's ability. As a result of such limitations, optimal, efficient, and/or effective logistical scheduling may not be achieved.

The present disclosure is generally directed to generation and/or simulation of a logistical transportation schedule, in particular for vehicles, such as, for example, cargo vehicles, waterway vessels, trains including cargo rail cars and/or tank cars, and/or cargo trucks and/or tankers. Although “waterway vessels” are referenced herein for the purpose of explanation, other types of vehicles are contemplated, including other waterborne vehicles, land borne vehicles, and airborne vehicles. Such a logistical transportation schedule may be determined for one or more different shipping requests, for example, based on demand. Transportation of materials may result in generation vast amounts of related historical data. Even shipments scheduled and/or executed over a single day or other relatively short time interval may result in generation of large amounts of related data. Such large sets of data, previously generated or contemporaneously generated, may be used to develop an analytical model, such as a machine learning algorithm and/or a mathematical model, which is able to generate efficient, effective, and/or optimized logistical transportation schedules. Such an efficient, effective, and/or optimized logistical transportation schedule may result in consumption of relatively less fuel or other resources, may be completed relatively more quickly, may result in distribution of relatively more types of materials, and/or may improve (e.g., ensure) compliance with local and/or regional government rules and/or regulations, for example, as compared to a typically formulated logistical schedule (e.g., a logistical schedule prepared by a human scheduler).

In some embodiments, the systems, apparatuses, and methods may, in addition to, or alternatively to, determining a logistical transportation schedule, may simulate an efficient, effective, and/or optimized logistical transportation schedule. For example, an event simulation model may receive an efficient, effective, and/or optimized logistical transportation schedule as an input, and simulate execution of the logistical transportation schedule, thereby to provides the result of the simulated logistical transportation schedule. In some embodiments, the event simulation model may be adjusted (e.g., via an input) to simulate the occurrence of one or more different scenarios (e.g., weather-based events, societal events, other delays, non-natural events, fluctuations in demand of a particular material, and/or a fluctuation in fuel availability and docking or parking slot availability to load and/or unload material). In such examples, the event simulation model may execute a simulation of the logistical transportation schedule and predict the effects of the parameters or scenarios selected. The event simulation model may thereafter output an efficient, effective, and/or optimized logistical transportation schedule, an adjusted logistical transportation schedule, for example, upon each result of each simulation, and/or a comparison of an efficient, effective, and/or optimized logistical transportation schedule and the adjusted logistical transportation schedule.

In some embodiments, for example, those including an analytical model, such as a mathematical model and/or machine learning model (e.g., such as in a route determination module, engine, and/or circuitry) and the event simulation model, may further include a graphical user interface (GUI). The GUI may facilitate interaction by a user of the system with the generated logistical transportation schedule and/or review of the results of the simulated logistical transportation schedule. The GUI may enable a user to prompt or initiate generation and/or simulation of a logistical transportation schedule. Further, in some embodiments, the GUI may enable a user to input a custom or user-defined logistical transportation schedule and simulate such a logistical transportation schedule. The simulated custom or user-defined logistical transportation schedule may be compared to a simulated efficient, effective, and/or optimized logistical transportation schedule generated by the analytical model (e.g., by the machine learning model). The GUI, in some embodiments, may enable a user to enter in a logistical transportation schedule, simulate the logistical transportation schedule, and/or generate an efficient, effective, and/or optimized logistical transportation schedule.

In at least some embodiments, an efficient, effective, and/or optimized logistical transportation schedule may be generated and/or simulated to determine potential improvements. The generation or determination of an efficient, effective, and/or optimized logistical transportation schedule may leverage numerous data elements (e.g., thousands or more data elements), many of the data elements being generated or determined in real-time for one or more shipping requests. Such determinations may not otherwise be possible (e.g., without the assistance of assemblies, systems, and/or described herein). The simulation of such a logistical transportation schedule may increase the likelihood (e.g., ensure) that any potential improvements may be identified. The simulation, in some embodiments, may increase the likelihood or ensure that various potential scenarios are accounted for or considered in relation to the logistical transportation schedule.

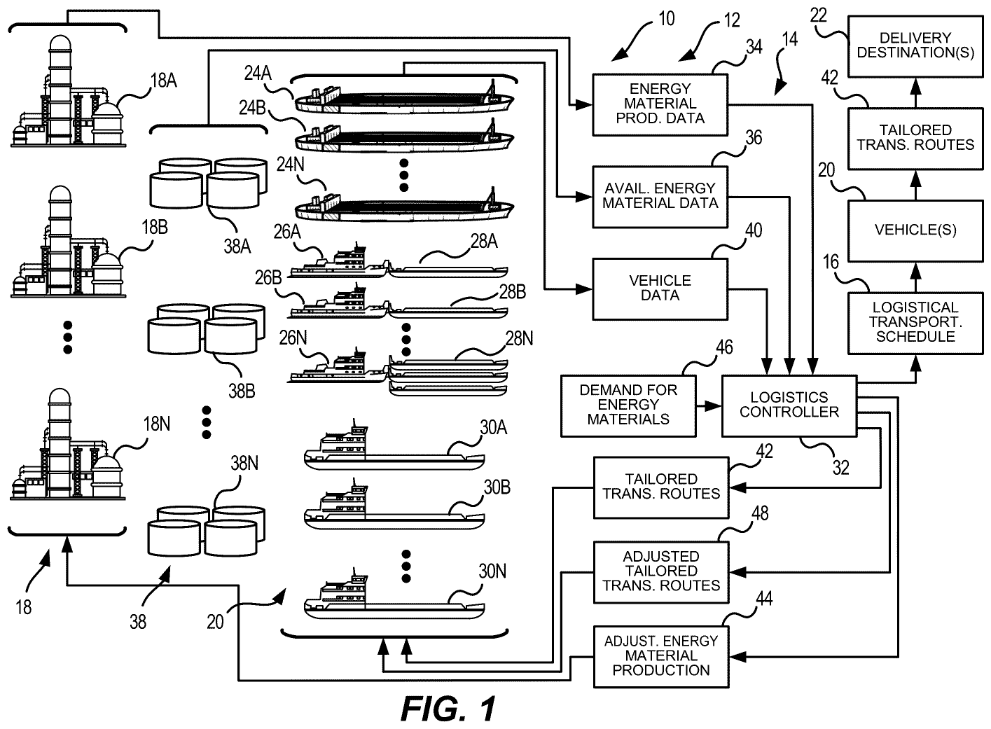

In one or more embodiments, as illustrated in FIGS. 1-11, for example, the present disclosure is directed to assemblies, systems, and methods for generating a logistical transportation schedule for logistical coordination between one or more selected vehicles for energy material distribution between material production facilities, material storage facilities, and delivery destinations.

FIG. 1 is a schematic block diagram of an example energy material production and delivery system 10, including an example vehicle system 12 and an example scheduling system 14 for enhancing generation of a logistical transportation schedule 16 for delivery of energy materials from one or more energy material production facilities 18 (18A and 18B, thru 18N), via, for example, a plurality of vehicles 20, to one or more delivery destinations 22, according to embodiments of the disclosure. Although “waterway vessels” are referenced herein for the purpose of explanation, other types of vehicles are contemplated, such as, for example, other waterborne vehicles, land borne vehicles, and/or airborne vehicles. In some embodiments, the energy material production facilities 18 may include, for example, one or more of: (a) one or more hydrogen production facilities, (b) one or more refineries, (c) one or more synthetic fuel production facilities, or (d) one of more renewable fuel production facilities. Although FIG. 1 schematically depicts energy material production facilities 18 including refineries, other types of energy material productions facilities are contemplated.

In some embodiments, one or more vehicles 20 may be loaded and/or unloaded at one or more energy material production facilities 18. In some embodiments, one or more vehicles 20 may be loaded and/or unloaded at more than one location (e.g., at more than one energy material production facility 18, at more than one storage facility, and/or at more than one delivery destination 22). For example, a vehicle 20 may travel along a tailored transportation route and receive energy material from multiple energy production facilities 18, storage facilities, and/or delivery destinations 22 along the route, and/or a vehicle 20 may unload energy material at multiple energy production facilities 18, storage facilities, and/or delivery destinations 22 along the route. In some embodiments, a vehicle 20 may travel along the route and both receive and/or unload energy material at various locations along the route.

The energy materials may include one or more of: hydrogen (e.g., green hydrogen produced by electrolyzers supplied with power from renewable energy sources; pink hydrogen produced by electrolyzers supplied with power by a nuclear energy source; gray hydrogen produced from natural gas via steam methane reforming with CO₂ emissions released to the atmosphere; and blue hydrogen produced via natural gas via steam methane reforming with CO₂ captured), renewable feedstock (e.g., cooking oil, animal fat, or other known renewable feedstocks), products from renewable feedstocks, hydrocarbon material, bio-mass, bio-fuel, bio-diesel, ethanol, synthetic fuel, renewable fuel, ethanol, hydrocarbon fuel, non-hydrocarbon fuel, petroleum-derived materials, petroleum feedstock, crude oil, tight oil, heavy crude oil, extra heavy crude oil, sand bitumen, light naphtha, gasoline, heavy naphtha, kerosene, diesel fuel, jet fuel, light gas oil, heating oil, light ends, heavy gas oil, lubricating oil, vacuum gas oil, residuum, paraffins, coke, asphalt, or precursors or derivatives thereof. Other types of energy materials are contemplated.

In some embodiments, the vehicles 20 may include one or more waterway vessels, for example, one or more tankers (24A and 24B thru 24N), one or more tow boat (26A and 26B thru 26N) and barge (28A and 28B thru 28N) combinations, one or more barges (30A and 30B thru 30N), one or more cargo ships, one or more boats, or one or more bulk carriers. Other types of vehicles are contemplated, including other types of waterborne vehicles, land borne vehicles, or airborne vehicles.

As shown in FIG. 1, in some embodiments, the scheduling system 14 may include a logistics controller 32 in communication with one or more of the vehicles 20, (b) one or more of the energy material production facilities 18, or (c) one or more of the delivery destinations 22. For example, communication may be facilitated according to known network communications protocols, such hard-wired protocol and/or wireless protocols. For example, the scheduling system 14 may include communications circuitry associated with one or more of: (a) one or more of the vehicles 20, (b) one or more of the energy material production facilities 18, or (c) one or more of the delivery destinations 22, and/or remotely therefrom. The communications circuitry may include at least one device or circuitry embodied in either hardware or a combination of hardware and software that is configured to receive and/or transmit data from/to a network and/or from/to any other device(s), circuitry, or module(s) in communication with the scheduling system 14. In some embodiments, the communications circuitry may include, for example, a network interface for enabling communications with a wired or wireless communication network. For example, the communications circuitry may include one or more network interface cards, antennas, buses, switches, routers, modems, and supporting hardware and/or software, or any other device(s) suitable for enabling communications via a network. In some embodiments, the communications circuitry may include processing circuitry for causing transmission of such signals to a network or for handling receipt of signals received from a network. Although the logistics controller 32 is depicted as a single block, the logistics controller 32 may include one or more controllers.

In some embodiments, as shown in FIG. 1, the logistics controller 32 may be configured to obtain (e.g., receive) one or more of: (a) energy material production data 34, based at least in part on output of energy materials from the one or more energy material production facilities 18; and (b) available energy material data 36, based at least in part on energy materials stored at one or more of: (1) one or more of the one or more energy material production facilities 18 or (2) one or more storage facilities 38. In some embodiments, the one or more storage facilities 38 may include one or more tank farms, although other types of storage facilities 38 are contemplated.

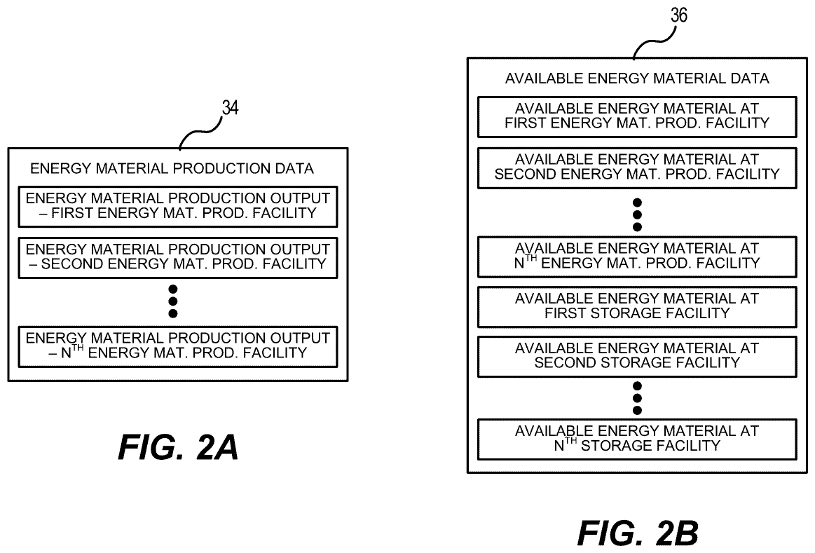

FIG. 2A is a block diagram of example energy material production data 34, according to embodiments of the disclosure, and FIG. 2B is a block diagram of example available energy material data 36, according to embodiments of the disclosure. The energy material production data 34 may include, for example, the energy material output capable by the one or more energy material production facilities 18 and/or the type of energy material able to be produced by the one or more energy material production facilities. Other types of data associated with the energy material production facilities 18 are contemplated. The available energy material data 36 may include, include for example, (a) the amount of energy material available (e.g., already produced) at the one or more energy material production facilities 18 and/or at the one or more storage facilities 38, and/or (b) the type of energy material available at the one or more energy material production facilities 18 and/or at the one or more storage facilities 38. Other types of data associated with the storage facilities 38 are contemplated.

The logistics controller 32 further may be configured to obtain (e.g., receive) vehicle data 40 for a plurality of the vehicles 20 (e.g., waterway vessels and/or other types of vehicles). The logistics controller 32 further may be configured to determine, via an analytical route model, a tailored transportation route 42 for at least some of the plurality of vehicles 20 based at least in part on: (a) the energy material production data 34, (b) the available energy material data 36, and (c) the vehicle data 40.

In some embodiments, as shown in FIG. 1, the logistics controller 32 may be configured to determine adjusted energy material production 44 for the one or more energy material production facilities 18 based at least in part on: (a) the energy material production data 34, (b) the available energy material data 36, and (c) demand for the energy materials 46. For example, the demand for energy materials 46 may be indicative of orders or sales of one or more types of the energy materials that may be supplied via one or more corresponding delivery destinations 22. In some embodiments, the adjusted energy material production 44 may include a type of energy material or materials and/or an amount of the energy material(s) to produce by the one or more of energy material production facilities 18, for example, to meet the demand at least partially for the energy materials 46.

For example, the logistics controller 32 may receive and/or determine an initial tailored transportation route 42 for one or more of the vehicles 20. This may be based at least in part on existing production schedules at one or more of the energy material production facilities 18. As described herein, the logistics controller 42 may be configured to determine whether it might be more efficient to adjust the existing production schedule at one or more of the energy material production facilities 18, for example, to meet the demand or energy material delivery schedules.

As shown in FIG. 1, the logistical controller 32 further may be configured to determine an adjusted tailored transportation route 48 based at least in part on the adjusted energy material production 44. The adjusted tailored transportation route 48 may include route-related adjustments of the tailored transportation route 42 for one or more of the vehicles 20. Such adjustments may take advantage of efficiencies or other factors related to the adjusted energy material production 44. In some embodiments, the adjusted tailored transportation route 48 further may include adjustment of the type of vehicle 20 for at least one of the vehicles 20.

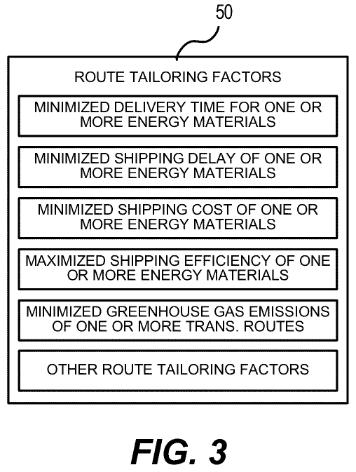

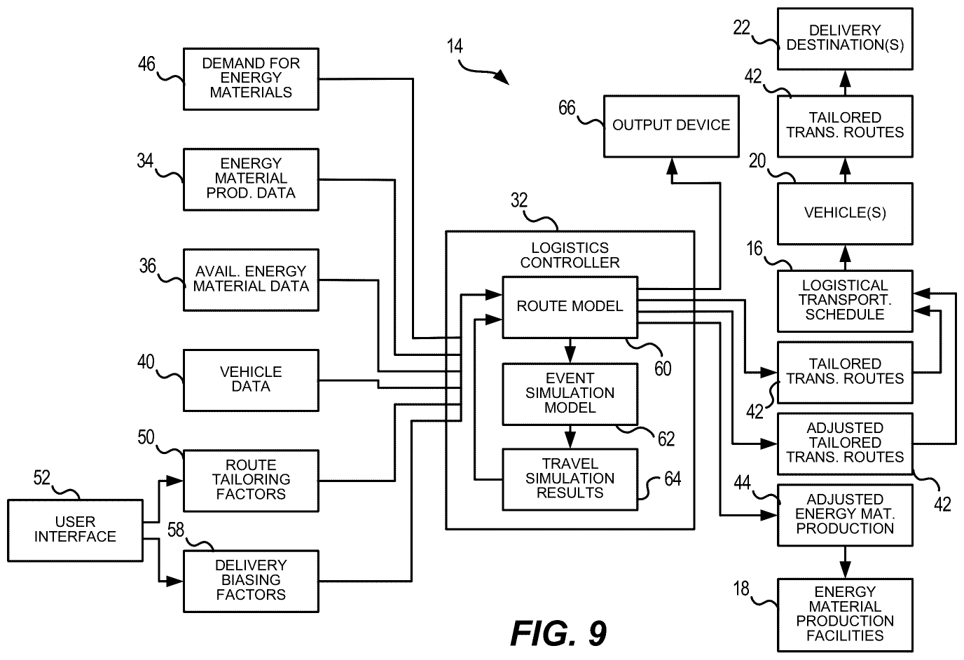

In some embodiments, the logistics controller 32 may be configured to determine the tailored transportation route 42 and/or the adjusted tailored transportation route 48 based at least in part on one or more route tailoring factors 50 (see, e.g., FIG. 9). As shown in FIG. 3, the route tailoring factors 50 may include one or more of: (a) minimized delivery time associated with delivery of one or more of the energy materials to the delivery destination; (b) minimized likelihood of shipping delay associated with delivery of one or more of the energy materials to the delivery destination due at least in part to one or more travel delays; (c) minimized shipping cost associated with delivery of one or more of the energy materials to the delivery destination; (d) maximized shipping efficiency associated with delivery of one or more of the energy materials to the delivery destination; or (e) minimized greenhouse gas emission associated with delivery of one or more of the energy materials to the delivery destination. The route tailoring factors 50, in some embodiments, may enable tailoring the logistical transportation schedule 16 toward desired outcomes, such as, for example, the logistical transportation schedule 16 that results in one or more of: (a) minimized delivery times; (b) minimized likelihood of shipping delays; (c) minimized shipping costs; (d) maximized shipping efficiency; or (e) minimized greenhouse gas emissions. In some embodiments, one or more of the route tailoring factors 50 may be input automatically and/or manually via a user interface 52 (see, e.g., FIG. 9). Other route tailoring factors 50 are contemplated.

For example, in some embodiments, the route tailoring factors 50 may be used to bias the logistical transportation schedule 16 to provide a logistical transportation solution that results in a relatively greater likelihood (or greater certainty) that a favored outcome occurs. For example, it may be desired that minimized delivery times are obtained, for example, even if such minimized delivery times are achieved at the expense of minimized shipping costs. For example, by biasing the solution toward minimized delivery times, it may result in relatively greater shipping costs. In another example, if maximized shipping efficiencies are desired and initiated, shipping times may be increased and/or greater greenhouse gas emissions may be incurred.

In some embodiments, the route tailoring factors 50 may provide the scheduling system 14 (and/or an operator of the scheduling system 14) with an ability to favor certain characteristics of the logistical transportation schedule 16 over other outcomes, for example, (a) minimized delivery times over maximized shipping efficiency, over minimized likelihood of shipping delays, over minimized shipping costs, and/or over minimized greenhouse gas emissions; (b) minimized likelihood of shipping delays over minimized delivery times, over minimized shipping costs, and/or over minimized greenhouse gas emissions; (c) maximized shipping efficiency over minimized delivery times, over minimized likelihood of shipping delays, over minimized shipping costs, and/or over minimized greenhouse gas emissions; and/or (d) minimized greenhouse gas emissions over minimized delivery times, over maximized shipping efficiency, over minimized likelihood of shipping delays, and/or over minimized shipping costs.

In some embodiments, the scheduling system 14 may be configured such that an operator may use, for example, a user interface (see, e.g., FIG. 9) to input one or more route tailoring factors 50, according to desired outcomes. In some embodiments, more than one route tailoring factor may be indicated by the operator, and in some embodiments, the multiple route tailoring factors 50 may be weighted, for example, in the form of ratios and/or percentages. For example, in order to achieve an outcome that favors minimized delivery times over maximized shipping efficiency, the weighting may bias the minimized delivery times over maximized shipping efficiency, for example, at a ratio of 4:1, 3:1, 2:1, or 1.5:1, among others, as will be understood by those skilled in the art. Other weighting ratios or weighting percentages are contemplated.

In some embodiments, as shown in FIG. 1, the logistics controller 32 further may be configured to determine the logistical transportation schedule 16, for example, for each of at least some of the vehicles 20, thereby to enhance the delivery of the energy materials from the energy material production facilities 18, via the vehicles 20, to the relevant delivery destinations 22. In some embodiments, the logistical transportation schedule 16 may identify one or more of: (a) a vehicle 20, (b) an energy material production facility 18 supplying energy material to the vehicle 20, (c) a storage facility 38 supplying energy material to the vehicle 20, (d) a delivery destination 22 for the vehicle 20, (e) a tailored transportation route 42 for the vehicle 20 from the energy material production facility 18 to the delivery destination 22, (f) or a tailored transportation route 42 for the vehicle 20 from the storage facility 38 to the delivery destination 22.

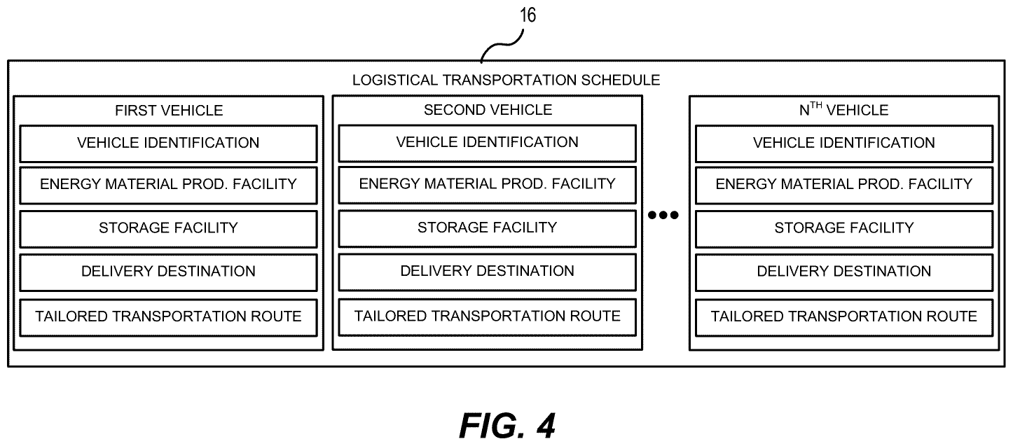

For example, FIG. 4 is a block diagram of an example logistical transportation schedule 16, according to embodiments of the disclosure. As shown in FIG. 4, some embodiments of the logistical transportation schedule 16 may include, for one or more of the vehicles 20 information associated with each of the one or more vehicles, such as, for example, (a) identification of the vehicle 20, (b) the energy material production facility 18 supplying energy material to the vehicle 20, for example, for its current travel route, (c) the storage facility 38 supplying energy material to the vehicle 20, for example, on its current travel route, (d) a delivery destination 22 for the vehicle 20, for example, on its current journey, (e) the tailored transportation route 42 for the vehicle 20 from the energy material production facility 18 to the delivery destination 22, (f) or a tailored transportation route 42 for the vehicle 20 from the storage facility 38 to the delivery destination 22. Other information associated with one or more of the vehicles 20 is contemplated.

In some embodiments, the logistics controller 32 further may be configured to simulate, via an analytical event simulation model (see, e.g., event simulation model 62 in FIG. 9), travel according to the tailored transportation route 42 for at least some of the vehicles 20, thereby to generate travel simulation results (see, e.g., travel simulation results 64 in FIG. 9). The logistics controller 32 also may be configured to determine one or more of (a) the adjusted energy material production data 34 or (b) the adjusted tailored transportation route 48, based at least in part on the travel simulation results. For example, the logistics controller 32 may receive or determine an initial tailored transportation route 42 for one or more of the vehicles 20. This may be based at least in part on existing production schedules at one or more of the energy material production facilities 18. For example, the logistics controller 32 may be configured to simulate, via an analytical event simulation model, travel according to an initial logistical transportation schedule 16 that includes the tailored transportation routes 42 for at least some of the vehicles 20. This may result in generating travel simulation results. Thereafter, the logistical controller 32 may be configured to determine whether it might be more efficient (compared against the travel simulation results) to adjust the existing production schedule at one or more of the energy material production facilities 18 and/or adjust one or more of the tailored transportation routes for the vehicles 20, for example, to meet the demand or energy material delivery schedules (or changes in the demand or energy material delivery schedules, or changes to other factors potentially affecting energy material delivery).

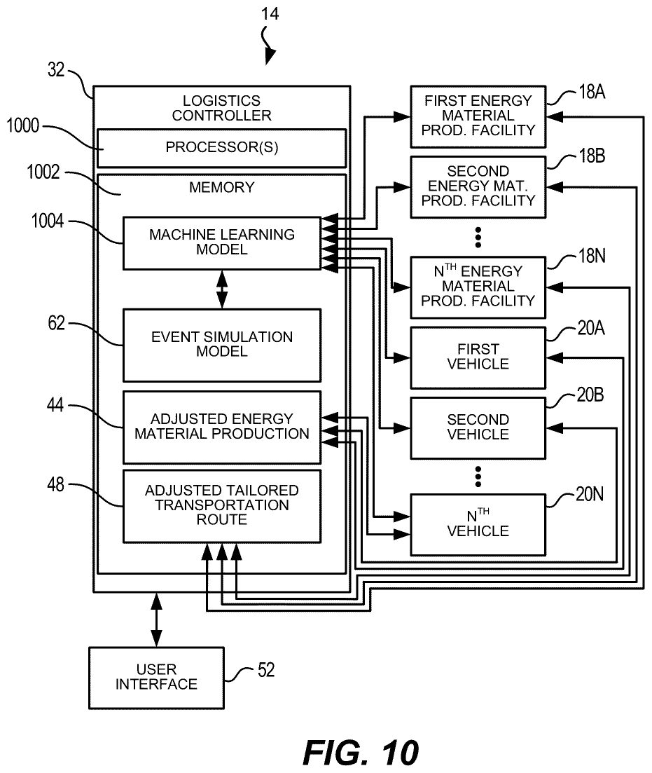

In some embodiments, the logistics controller 32 further may be configured to initiate travel according to the adjusted tailored transportation routes 48 for at least some of the vehicles 20, thereby to cause transport of the amount of energy materials produced by at least some of the energy material production facilities 18 to one or more of the appropriate delivery destinations 22. In some embodiments, the logistics controller 32 also may be configured to initiate performance of the adjusted energy material production 44 at one or more of the energy material production facilities 18 to cause production of the amount of energy materials by at least some of the energy material production facilities 18. In this example manner, the logistics controller 32 may cause implementation of production according to the adjusted energy material production, and/or travel of the vehicles 20 according to the adjusted tailored transportation routes 48. For example, the logistics controller 32 may communicate with one or more of the energy material production facilities 18 and/or one or more of the vehicles 20 to cause such implementations. Such communications may be performed between the logistics controller 32 and one or more production facility controllers (see, e.g., FIG. 10) associated with the energy material production facilities 18 and/or between the logistics controller 32 and one or more vessel controllers associated with the vehicles 20. Other forms of communication are contemplated, such as, for example, communication between people located at different energy material production facilities 18 and/or located at different vehicles 20.

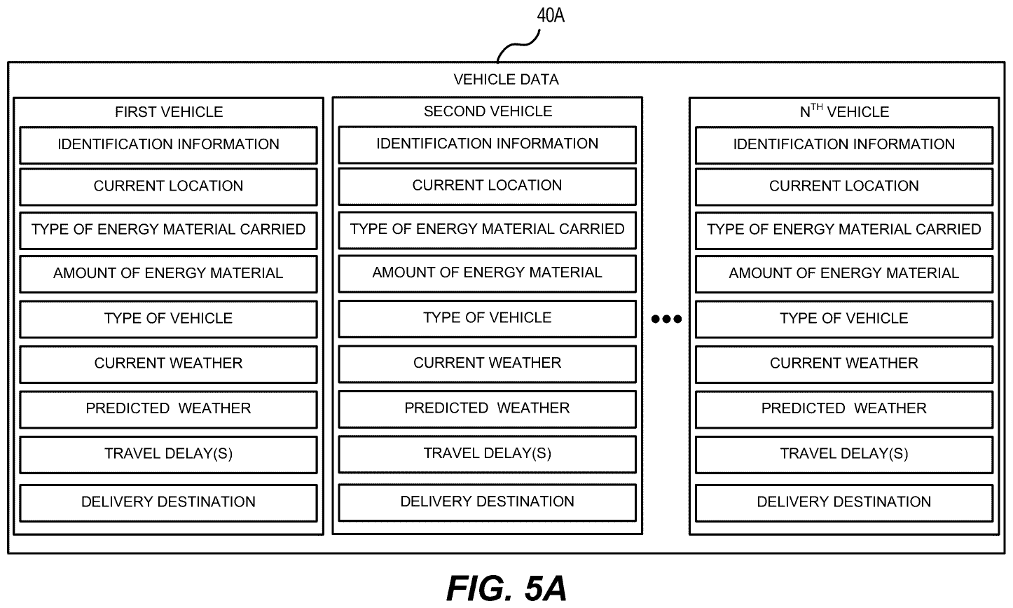

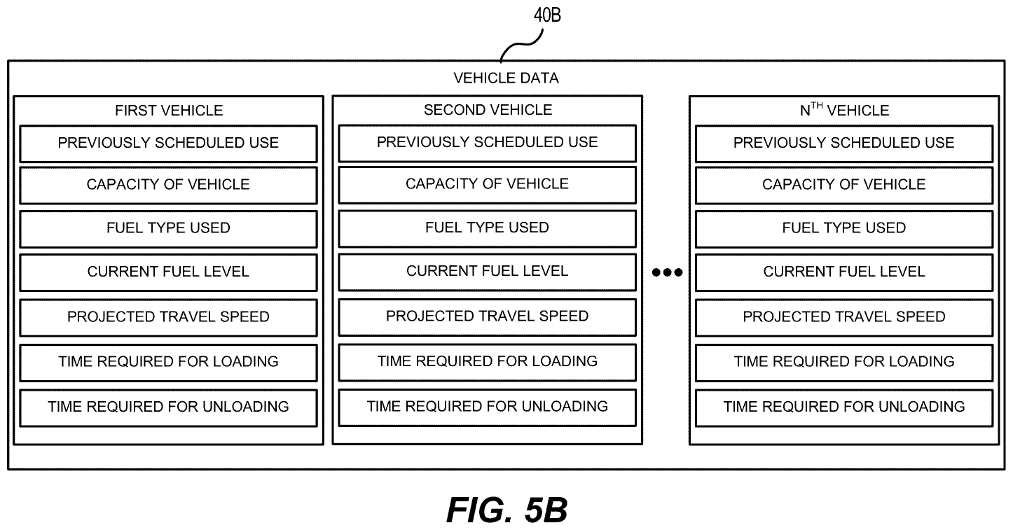

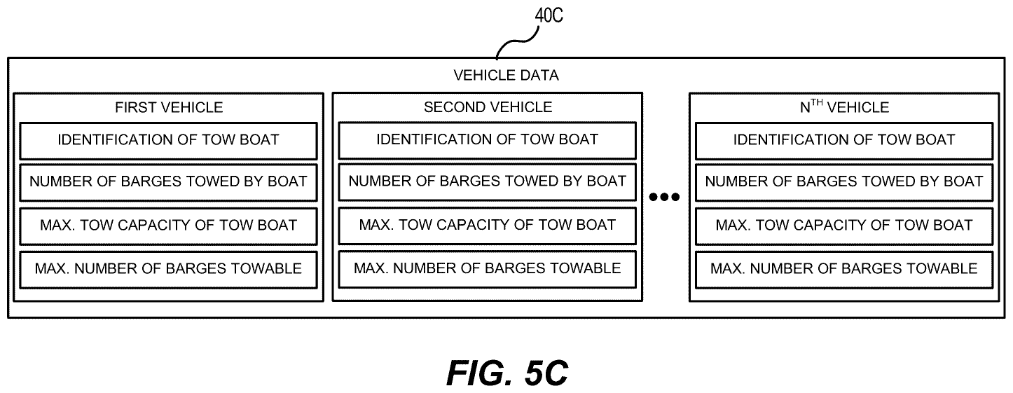

FIG. 5A is a block diagram of example vehicle data 40A, according to embodiments of the disclosure. FIG. 5B is a block diagram of further examples of vehicle data 40B, according to embodiments of the disclosure, and FIG. 5C is a block diagram of further examples of vehicle data 40C, according to embodiments of the disclosure. As shown in FIGS. 5A-5C, in some embodiments, the vehicle data 40 may include, for example, one or more of: (a) identification of one or more of the vehicles 20, (b) the current location of one or more of the vehicles 20, (c) the type(s) of energy material(s) carried by one or more of the vehicles 20, (d) the amount of energy material(s) carried by one or more of the vehicles 20, (e) the type of vehicle for one or more of the vehicles 20, (f) the current weather associated with one or more of the vehicles 20, (g) the predicted weather associated with one or more of the vehicles 20, (h) a travel delay(s) associated with one or more of the vehicles 20, or (i) the delivery destination 22 for one or more of the vehicles 20.

The current weather associated with one or more of the vehicles 20 may include current weather associated with the tailored transportation route 42 of the one or more of the vehicles 20. The predicted weather associated with one or more of the vehicles 20 may include future weather associated with the tailored transportation route 42 of the one or more of the vehicles 20.

In some embodiments, as shown in FIG. 5B, the vehicle data 40B may further include, for example, one or more of: (a) previously scheduled use of the vehicle 20, (b) the capacity of the vehicle 20, (c) the fuel type used by the vehicle 20, (d) the current fuel level of the vehicle 20, (e) the fuel usage rate for one or more of the vehicles 20; (f) the travel speed of the vehicle 20 while at least partially loaded, (g) the terminal availability for the vehicle 20 for loading the energy material, (h) the terminal availability for the vehicle 20 for unloading the energy material at the delivery destination 22, or (i) the terminal availability for the vehicle 20 for unloading and loading the energy material at the delivery destination 22.

In some embodiments, one or more of the vehicles 20 may include a tow boat (see, e.g., FIG. 1, 26A, 26B, thru 26N) and one or more barges (see, e.g., FIG. 1, 28A, 28B, thru 28N) towed by the tow boat. In some embodiments, the tow boats may push one or more barges. As shown in FIG. 5C, in at least some such embodiments, the vehicle data 40C further may include, for the one or more of the vehicles 20, one or more of: (a) identification of the tow boat, (b) the number of barges currently towed by the tow boat, (c) the maximum tow capacity of the tow boat, or (d) the maximum number of barges towable by the tow boat. Other vehicle data associated with tow boat and barge combinations is contemplated.

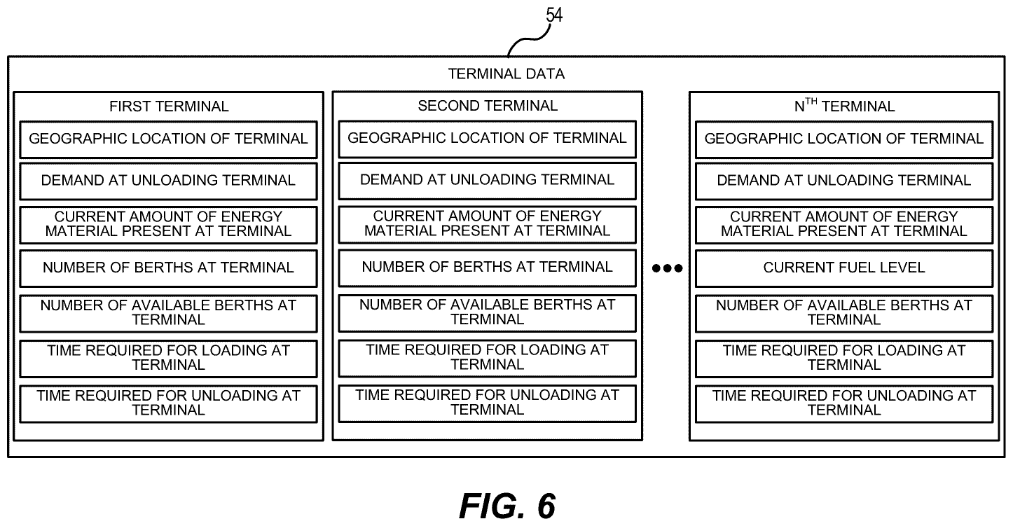

In some embodiments, the logistics controller 32 is further configured to obtain terminal data 54. FIG. 6 is a block diagram of example terminal data 54, according to embodiments of the disclosure. As shown in FIG. 6, in some embodiments, the terminal data 54 may include one or more of: (a) data associated with one or more of loading terminals at which energy material is loaded onto one or more of the vehicles 20 (e.g., at the energy material productions facilities 18 or the storage facilities 38); or (b) data associated with one or more unloading terminals at which energy material is unloaded from one or more of the vehicles 20 (e.g., at the delivery destinations 22). For example, as shown in FIG. 6, the terminal data 54 may include one or more of: (a) the geographic location associated with a respective loading terminal, (b) the geographic location associated with a respective unloading terminal, (c) the demand 46 at a respective unloading terminal associated with an energy material transported by one or more of the vehicles 20, (d) the amount of an energy material present at a respective unloading terminal associated with an energy material, (e) the number of berths at a respective loading terminal, (f) the number of berths at a respective unloading terminal, (g) the number of available berths at a respective loading terminal, or (h) the number of available berths at a respective unloading terminal. Other types of terminal data 54 are contemplated. In some embodiments, the vehicle data 40 and/or the terminal data 54 may include one or more of: (a) the amount of time for loading energy material onto a respective one of the vehicles 20, or (b) the amount of time for unloading energy material from a respective one of the vehicles 20.

According to some embodiments, the logistics controller 32 may be configured to one or more of: (a) determine the tailored transportation route 42 for at least some of the vehicles 20 based at least in part on the terminal data 54; (b) determine the adjusted energy material production based at least in part on the terminal data 54; (c) determine the adjusted tailored transportation route 48 based at least in part on the terminal data 54; or (d) determine the logistical transportation schedule 16 for at least some of the vehicles 20 based at least in part on the terminal data 54. Other use of the terminal data 54 by the logistics controller 32 is contemplated.

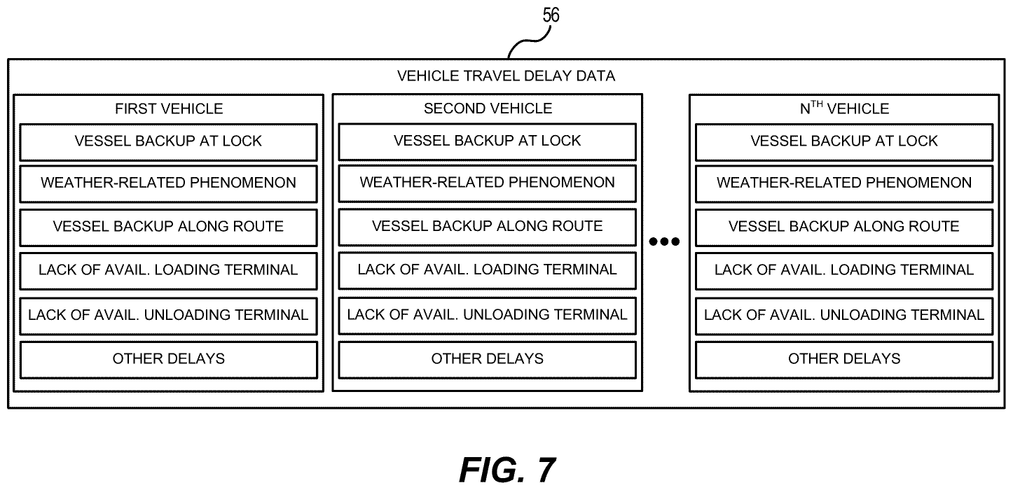

In some embodiments, the logistics controller 32 may be configured to receive travel delay data indicative of circumstances and/or events that may result in one or more of the vehicles 20 being delayed along its travel route to the delivery destination 22. As shown in FIG. 7, for example, the travel delay data 56 may include one or more of: (a) the travel delay due at least in part to a vehicle 20 back-up at one or more locks (e.g., river or canal locks) along the tailored transportation route 42, (b) the travel delay due at least in part to a weather-related phenomenon along the tailored transportation route 42, (c) the travel delay due at least in part to a vehicle 20 back-up along the tailored transportation route 42, (d) a lack of terminal availability for the vehicle 20 for loading the energy material, (e) a lack of terminal availability for the vehicle 20 for unloading the energy material at the delivery destination 22, or (f) the terminal availability for the vehicle 20 for unloading and loading the energy material at the delivery destination 22. Other types of travel delays are contemplated. The travel delay may include predicted travel delays, for example, which may be determined based at least in part on real-time data and/or based at least in part on historical data (e.g., from a data base). Other types of travel delay data 56 are contemplated.

In some embodiments, the logistics controller 32 may be configured to receive the energy production material data 34 from one or more energy material production controllers. The one or more of the energy material production controllers may be located at a respective energy material production facility 18 or remotely from a respective energy material production facility 18. In some embodiments, the logistics controller 32 may be configured to receive the available energy material data 36 from one or more of: (a) one or more energy material production controllers, or (b) one or more storage facilities 38. The logistics controller 32, in some embodiments, may be configured to receive the vehicle data 40 from one or more respective vehicles 20 or from a location remote from the vehicles 20. In some embodiments, the logistics controller 32 may be configured to receive one or more signals from one or more databases configured to store one or more of (a) the energy material production data 34, (b) the available energy material data 36, (c) or the vehicle data 40.

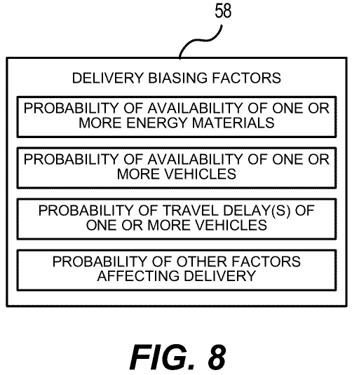

In some embodiments, the logistics controller 32 may be further configured to obtain (e.g., receive) one or more delivery biasing factors 58, for example, as shown in FIG. 8, which is a block diagram of example delivery biasing factors 58, according to embodiments of the disclosure. The logistics controller 32, in some embodiments, may be configured to determine one or more of: (a) the tailored transportation route for the at least some of the vehicles 20 based at least in part on the one or more delivery biasing factors 58; (b) the adjusted energy material production 44 based at least in part on the one or more delivery biasing factors 58; (c) the adjusted tailored transportation route 48 based at least in part on the one or more delivery biasing factors 58; or (d) the logistical transportation schedule 16 for at least some of the vehicles 20 based at least in part on the one or more delivery biasing factors 54. As shown in FIG. 8, the delivery biasing factors 58 may include, for example, one or more of: (a) the probability of availability of one or more of the energy materials; (b) the probability of availability of one or more of the vehicles 20; or (c) the probability of a travel delay associated with one or more of the vehicles 20. Other delivery biasing factors are contemplated. In some embodiments, one or more of the delivery biasing factors may be input automatically and/or manually via the user interface 52 (see, e.g., FIG. 9).

For at least some embodiments, the logistics controller 32 may be positioned remote of and/or in signal communication with a plurality of the vehicles 20 and may coordinate or control the communication, tracking, and/or logistics data between the plurality of vehicles 20 and sources of the energy materials and/or delivery destinations 22 (e.g., one or more ports, each including one or more docks). The logistics controller 32 may be configured to receive and/or transmit data from and between the one or more energy material production facilities 18 and/or one or more storage facilities 38, the plurality of vehicles 20, and one or more delivery destinations 22. In some embodiments, sensors and/or transmitters may be associated with, correspond to, or be positioned on each of the plurality of vehicles 20 to provide various statistics and characteristics (e.g., vehicle data 40) of an associated and/or corresponding vehicle 20 to the logistics controller 32. The logistics controller 32 may include instructions stored in a memory, as will be described in further detail below. The instructions may include instructions to generate the logistical transportation schedule 16 based on, for example, one or more shipping requests and/or inputs defined by various statistics and characteristics of the one or more energy material production facilities 18 and/or the one or more storage facilities 38, of the one or more delivery destinations 22, of the plurality of vehicles 20, and/or related to other factors, such as, for example, the demand for energy materials 46 (e.g., demand or current quantity of a particular product or good at a particular location). In some embodiments, such instructions may be executed in response to an operator or user input (e.g., reception of a shipping request, or a request by the operator or user for generation of a logistical transportation schedule), and/or such instructions may be based at least in part on reception of various data points and/or types of data (e.g., receipt of a delivery or shipping request, receipt of an order, etc.). The instructions may further include a route module (see, e.g., route model 60 in FIG. 9). The route module may include an analytical route model, such as a mathematical model and/or machine learning model. The inputs may be applied to the route model to determine, produce, and/or generate a logistical transportation schedule 16 (e.g., an efficient, effective, and/or optimized logistical transportation schedule). Such a route model, in some embodiments, (e.g., the machine learning model) may be generated based on training data using previously completed and/or tagged logistical transportation schedules. The route model, in some embodiments, may be updated based at least in part on subsequently completed logistical transportation schedules and/or associated data. In some embodiments, the logistics controller 32 may include instructions to simulate events (e.g., discrete events), for example, via an event simulation model (see, e.g., event simulation model 62 in FIG. 9). The event simulation model may be configured to simulate a logistical transportation schedule 16 to determine one or more potential delays and/or to refine the logistical transportation schedule 16.

In some embodiments, sensors may be positioned at the one or more energy material production facilities 18, at the one or more storage facilities 38, and/or on one or more of the vehicles 20. Additional sensors may be positioned along one or more of the routes or waterways, at one or more delivery destinations 22 (e.g., at each of one or more terminals or ports), and/or at other various locations along a potential transportation route. The sensors may be in signal communication with the logistics controller 32 and provide, via signal communication, various statistics and/or characteristics related to the one or more energy material production facilities 18 and/or one or more storage facilities 38, and/or the vehicles 20 (e.g., vehicle data 40). In some embodiments, the one or more energy material production facilities 18 and/or one or more storage facilities 38, the one or more of the vehicles 20, the one or more delivery destinations 22 (e.g., ports), and/or other locations may include, in addition to or instead of, sensors, a computing device, controller, and/or sub-controller. The computing device, controller, and/or sub-controller may be configured to provide data (e.g., vehicle data 40), for example, relating to the one or more energy material production facilities 18 and/or one or more storage facilities 38, the capacity of the associated vehicle 20, the current capacity available of the vehicle 20, the geographic location of the vehicle 20, the destination of the vehicle 20, current logistical schedules assigned to the vehicle 20, the type of fuel utilized by the vehicle 20, the maximum speed of the vehicle 20, the current traveling speed of the vehicle 20, a scheduled maintenance period for the vehicle 20, the origin of the vehicle 20, the current and previous number of crew members on the vehicle 20, the country of origin of each current and previous crew member aboard the vehicle 20, and/or the amount of fuel carried by the vehicle 20. Such data may be communicated to and/or received by the logistics controller 32 for use in determining the logistical transportation schedule 16, for example, via the analytical model (e.g., a mathematical model and/or a machine learning model), as described herein. Other electronic devices may be included to measure and/or indicate one or more characteristics of the one or more energy material production facilities 18 and/or one or more storage facilities 38, a vehicle 20, and/or other location (e.g., such as a global positioning system), flow meters, temperature sensors, level sensors, and/or a speedometer, among other electronic devices able to provide input to the logistics controller 32.

In some embodiments, circuitry and/or a module including, for example, the route model, may be configured to track the locations of the one or more of vehicles 20. For example, such tracking may be enabled based at least in part on one or more sensors described herein and/or by computing devices corresponding to the one or more vehicles 20.

The logistics controller 32 may include one or more communication devices configured to enable signal communication with the sensors and/or other electronic devices associated with the one or more vehicles 20 to determine and/or track the current location of the one or more vehicles 20, among other characteristics (e.g., via route determination circuitry and/or other circuitry or instructions associated with the logistics controller 32). In some embodiments, the one or more communication devices may enable communication with sensors and/or other electronic devices at the one or more energy material production facilities 18, the one or more storage facilities 38, and/or the one or more delivery destinations 22 (e.g., one or more terminals or ports), for example, to receive information related to the one or more delivery destinations 22 and/or to transmit signals indicative of actions to be performed at the one or more delivery destinations 22. In some embodiments, the one or more communication devices may enable communication between the one or more energy material production facilities 18, the one or more storage facilities 38, the one or more delivery destinations 22, and/or the one or more vehicles 20.

In some embodiments, the logistics controller 32 may include a computing device. The computing device may include one or more of programmable logic controllers (PLCs), programmable automation controllers (PACs), industrial computers, desktop computers, workstations, personal data assistants (PDAs), laptop computers, tablet computers, smart-books, palm-top computers, personal computers, smartphones, wearable devices (e.g., headsets, smartwatches, or the like), a server (e.g., a rack server, blade server, cluster, etc.), or similar electronic devices equipped with at least a processor and any other physical components to perform the various operations described herein.

The logistics controller 32 may be configured to receive data (e.g., statistics and/or characteristics) from sensors and/or other electronic devices. the logistics controller 32 may be configured to receive such data, for example, in real-time and continuously, substantially continuously, at specified intervals, and/or upon request (e.g., a request from the logistics controller 32 or a user or operator). In some embodiments, large amounts of data may be received and/or collected. Such data may be stored at the logistics controller 32 and/or at an associated storage readable medium, such as a database.

In some embodiments, using the data received and/or a shipping request, the logistics controller 32 may be configured to determine, via an analytical model (e.g., a mathematical model and/or a machine learning model (e.g., of a route model, engine, or circuitry), the logistical transportation schedule 16. In some embodiments, the logistics controller 32 may be configured to apply the data and one or more shipping requests to the analytical model. For example, the analytical model may use selected mathematical functions, probabilistic models, and/or machine learning algorithms, to apply the data and one or more shipping requests to determine the logistical transportation schedule 16. In some embodiments, the logistics controller 32 may be configured to simulate execution of the logistical transportation schedule 16, thereby to produce travel simulation results, and, in some embodiments, adjust the logistical transportation schedule based on the travel simulation results. The logistics controller 32 may initiate (or indicate initiation of) the logistical transportation schedule 16 (or the adjusted logistical transportation schedule), for example, by communicating instructions to the one or more energy material production facilities 18, the one or more storage facilities 38, the one or more vehicles 20, and/or one or more of the delivery destinations 22.

The logistics controller 32, in some embodiments, may be configured to generate or produce the simulation results based on a simulation of the logistical transportation schedule 16. The simulation results may include data and/or statistics regarding the executed logistical transportation schedule 16, such as, for example, time for delivery, cost, and/or amount of fuel utilized, distance traveled, and/or other potential characteristics and/or problems experienced during execution of the logistical transportation schedule 16. Based at least in part on these simulation results, the logistics controller 16 may be configured to automatically adjust (or determine adjustments to) the logistical transportation schedule 16. For example, if a weather-related event or other type of event is anticipated, for example, at a probability greater than or equal to a predetermined threshold probability, to occur along a route specified in the logistical transportation schedule, the logistics controller 32 may determine other routes with a lower probability of experiencing a weather-related event or other type of delaying event. The logistics controller 32 may be configured to automatically update the logistical transportation schedule 16 or display alternative routes along with the logistical transportation schedule 16 via a user interface, such as a display device. In some embodiments, the controller 102 may be configured to determine an adjustment for the logistical transportation schedule 16, for example, if the probability exceeds a preselected or predetermined threshold probability. In some examples, the simulation results may illustrate or show that potential delays and/or other issues may occur with some level of probability, and based at least in part on one or more thresholds, determine adjustments for the logistical transportation schedule 16.

In some embodiments, a shipping request may include, for example, an amount and/or type of energy material to be shipped, an origin (e.g., an energy material production facility 18 and/or storage facility 38), a destination (e.g., a delivery destination 22, such as a terminal or port), and/or a time range for delivery. In some embodiments, the logistical transportation schedule 16 may include, for example, data related to a particular transportation operation or process. For example, the logistical transportation schedule 16 may identify one or more energy material production facilities 18, one or more storage facilities 38, one or more vehicles 20, one or more selected delivery destinations 22 and/or other selected locations, one or more berths or docks at the one or more selected delivery destinations 22, the dimensions of selected berths or docks (e.g., width, length, and/or depth), a transportation route, an amount of energy material to be received from one or more of the energy material production facilities 18 and/or one or more storage facilities 38, an amount of energy material to be delivered to the one or more selected delivery destinations 22, a time and/or date for pickup and/or delivery, and/or other data related to a particular transportation operation or process.

FIG. 9 is a schematic block diagram of an example scheduling system 14 for enhancing generation of a logistical transportation schedule 16 for delivery of energy materials from one or more energy material production facilities 18 and/or one or more storage facilities 22 (FIG. 1), via one or more vehicles 20, to one or more delivery destinations 22, according to embodiments of the disclosure.

As shown in FIG. 9, in some embodiments, the logistics controller 32 may include (and/or may be in communication with) one or more of an analytical route model 60 or an analytical event simulation model 62. The analytical route model 60, in some embodiments, may be configured to determine the tailored transportation route 42 for at least some of the vehicles 20, for example, as described herein. The analytical event simulation model 62, in some embodiments, may be configured to simulate travel according to the tailored transportation route 42 for at least some of the vehicles 20, thereby to generate travel simulation results 64, for example, as described herein. In some embodiments, the analytical route model 60 and/or the analytical event simulation model 64 may include a machine learning analytical model. As described herein, in some embodiments, the logistics controller 32 may be configured to simulate, for example, via the analytical event simulation model 62, travel according to the tailored transportation route 42 for at least some of the vehicles 20, thereby to generate the travel simulation results 64.

As shown in FIG. 9, in some embodiments, the scheduling system 14 may further include an output device 66. The output device 66 may include any device for providing information to a user, such as, for example, a display device. For example, in some embodiments, the logistics controller 32 may be configured to cause display of, for example, via a display device, an annotated map showing one or more of: (a) one or more of the vehicles 20, (b) one or more of the energy material production facilities 18, (c) one or more of the storage facilities 38, (d) one or more of the delivery destinations 22, (e) the tailored transportation route(s) 42 of at least some of the vehicles 20, or (f) the adjusted tailored transportation route(s) 48 of at least some of the vehicles 20. The display of other relevant representations of information related to the logistical transportation schedule 16 are contemplated.

For example, the logistics controller 32 may be configured to cause display of a simulation of one or more of the vehicles 20 traveling according to one or more of (a) the tailored transportation route 42 or (b) the adjusted tailored transportation route 48. In some embodiments, the logistics controller 32 may be configured to cause dynamic display of the simulation, for example, showing various portions of the display moving in real-time, or simulating movement in real-time, for example, during a simulation. In some embodiments, the logistics controller 32 may be configured to cause display, via a display device, of one or more of: (a) the energy material production data 34, (b) the available energy material data 36, (c) or the vehicle data 40.

In some embodiments, the logistics controller 32 may be in communication with one or more of: (a) one or more of the vehicles 20, (b) one or more of the energy material production facilities 18, one or more storage facilities 38 (see FIG. 1), or (c) one or more of the delivery destinations 22. The logistics controller 32 may receive information related to one or more of those entities in the form of, for example, as shown in FIG. 9, (a) demand for energy materials 46 (e.g., from the delivery destinations 22 and/or from a one or more energy material consumers (e.g., including the terminal data 54 shown in FIG. 6)), (b) energy material production data 34 (e.g., from the one or more energy material production facilities 18, for example, from production controllers and/or databases associated with respective energy production facilities 18 (see, e.g., FIG. 2A)), (c) available energy material data 36 (e.g., from the one or more energy material productions facilities 18 and/or one or more storage facilities 38 (see, e.g., FIGS. 1 and 2B)), and/or (d) vehicle data 40 (e.g., from the one or more vehicles 20 (e.g., FIGS. 1 and 5A, 5B, and 5C)).

In some embodiments, the logistics controller 32, based at least in part on the information received, may be configured to generate initial tailored transportation routes 42 for one or more of the vehicles 20 and/or an initial logistical transportation schedule 16, for example, to meet the demand for energy materials 46. In some embodiments, the initial tailored transportation routes 42 for one or more of the vehicles 20 and/or the initial logistical transportation schedule 16 may be optimized based on one or more criteria or preferences, for example, as described herein. For example, a user or operator may use the user interface 52 to input one or more route tailoring factors 50 and/or one or more delivery biasing factors 58, which may be used by the logistics controller 32 to generate the initial tailored transportation routes 42 for one or more of the vehicles 20 and/or the initial logistical transportation schedule 16. For example, the logistics controller 32, in some embodiments, may include a route model 60 that may be configured to generate the initial tailored transportation routes 42 for one or more of the vehicles 20 and/or the initial logistical transportation schedule 16, for example, as described herein.

In some embodiments, the logistics controller 32 may be configured to determine production schedules or targets for producing energy materials for one or more of the energy material production facilities 18. The schedules or targets may be tailored to provide the energy production materials to meet the demand and facilitate execution of the delivery of appropriate energy materials to the appropriate delivery destinations, substantially adhering to the initial logistical transportation schedule 16. In some embodiments, the initial logistical transportation schedule 16 may be consistent with the initial tailored transportation routes 42 determined or generated by the logistics controller 32. For example, the logistics controller 32 may be configured to determine production (e.g., the quantity of energy materials produced, the type of energy materials produced, the specifications (e.g., the content and/or characteristics) of energy materials produced, the time for production, the time corresponding to the beginning of production, and/or the time corresponding to a projected end of production) to facilitate achievement of meeting the demand for energy materials for the one or more delivery destinations 22. In some embodiments, the logistics controller 32 may, for example, be configured to determine production for the one or more energy material production facilities 18 that will enable energy material delivery according to the logistical transportation schedule 16. In some embodiments, the logistical controller 32 may be able to tailor or adjust the production of energy materials at the one or more energy material production facilities 18 in a manner that results in improvement of the logistical transportation schedule 16 in meeting the delivery goals of the energy materials for the delivery destinations 22. In some embodiments, the logistical controller 32 may be configured to communicate the tailoring or adjustment of the production, so that the one or more energy material production facilities 18 may alter their respective production schedules accordingly. In some embodiments, the tailoring or adjustments may be communicated to one or more production controllers (e.g., one or more production scheduling controllers) associated with the respective energy material production facilities 18. Such production controllers may be located locally (geographically) at the respective energy material production facility 18 and/or may be located remotely (geographically) from the respective energy material production facility 18. Thus, in some embodiments, the logistics controller 32 may be configured to take into account, and/or adjust or tailor, energy material production at one or more of the energy material production facilities 18 to optimize the logistical transportation schedule 16 to meet energy material demand at one or more of the delivery destinations 22. In some such embodiments, the optimization may be tailored according to the route tailoring factors 50 and/or the delivery biasing factors 58, for example, as described herein. In some embodiments, the route tailoring factors 50 and/or the delivery biasing factors 58 may be specified or controlled by an operator or user of the scheduling system 14, for example, via input using a user interface 52.

FIG. 10 is a simplified block diagram of a scheduling system 14 for determination and/or simulation of a logistical transportation schedule 16, according to embodiments of the disclosure. The scheduling system 14 may include a logistics controller 32, for example, as described herein. The logistics controller 32 may be configured to communicate with, wirelessly and/or via wired connection, one or more of the energy material production facilities 18A-18N, one or more of the vehicles 20A-20N, in some embodiments, one or more of the storage facilities 38A-38N (see, e.g., FIG. 1), and/or other electronic devices positioned at various geographic locations. The logistics controller 32 may include one or more processor(s) 1000 and/or memory 1002. The memory 1002 may be configured to store instructions executable by the one or more processor(s) 1000. In some embodiments, the memory 1002 may include or be a non-transitory machine-readable storage medium. As used herein, a “machine-readable storage medium” may include or be any electronic, magnetic, optical, or other physical storage apparatus or cyber-physical separation storage configured to contain or store information, such as executable instructions, data, and the like. For example, any machine-readable storage medium described herein may include or be any of random access memory (RAM), volatile memory, non-volatile memory, flash memory, a storage drive (e.g., hard drive), a solid-state drive, any type of storage disc, and the like, or combinations thereof. The memory 1002 may be configured to store and/or include instructions executable by the one or more processor(s) 1000. As used herein, a “processor” may include, for example, one processor or multiple processors included in a single device or distributed across multiple computing devices. The one or more processor(s) 1000 may include or be at least one of a central processing unit (CPU), a semiconductor-based microprocessor, a graphics processing unit (GPU), a field-programmable gate array (FPGA) to retrieve and execute instructions, a real-time processor (RTP), other electronic circuitry suitable for the retrieval and execution instructions stored on a machine-readable storage medium, or combinations thereof.

As used herein, “signal communication” may refer to electric communication, such as hardwiring two components together, and/or wireless communication, as understood by those skilled in the art. For example, wireless communication may include or be Wi-Fi®, Bluetooth®, ZigBee, and/or forms of near-field communications. In addition, signal communication may be facilitated by or include one or more intermediate controllers or relays disposed between elements in signal communication.

In some embodiments, the memory 1002 may be configured to store one or more analytical models, for example, as described herein, such as, for example, a machine learning model 1004, and/or an event simulation model 62. In some embodiments, the machine learning model 1004 and/or the event simulation model 62 may be configured to generate, for example, the logistical transportation schedule 16 (see, e.g., FIGS. 1 and 9), the tailored transportation routes 42, the adjusted tailored transportation routes 48, and/or the adjusted energy material production 44, for example, as described herein. In some embodiments, the logistical transportation schedule 16, the tailored transportation routes 42, the adjusted tailored transportation routes 48, and/or the adjusted energy material production 44 may be communicated to the energy material production facilities 18, the storage facilities 38, the vehicles 20, and/or the delivery destinations 22, for example, as described herein, so that the energy material production and/or operation of the vehicles 20 may be coordinated to result in delivery of the energy materials to the appropriate delivery destinations 22, for example, in a desired or optimized manner. In some embodiments, the memory 1002 may be configured to store modeling instructions, such as modeling instructions for determining the logistical transportation schedule 16, the tailored transportation routes 42, the adjusted tailored transportation routes 48, and/or the adjusted energy material production 44.

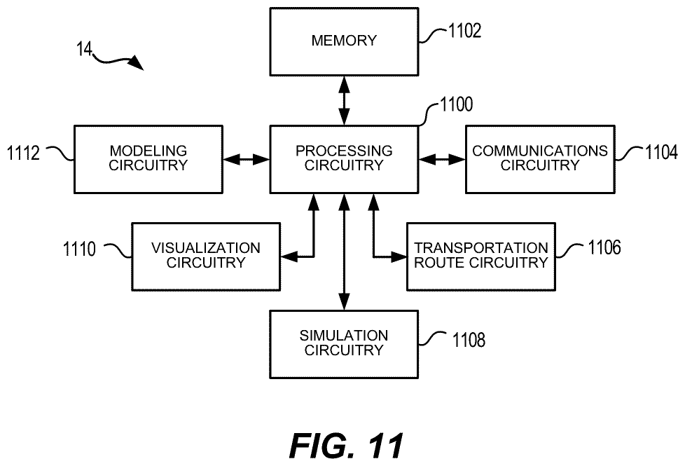

FIG. 11 is a simplified block diagram of a scheduling system 14 for determining and/or simulating a logistical transportation schedule 16, according to an embodiment of the disclosure. In some embodiments, the scheduling system 14 (or apparatus) may include processing circuitry 1100, memory 1102, communications circuitry 1104, transportation route circuitry 1106, simulation circuitry 1108, visualization circuitry 1110, and/or modeling circuitry 1112, for example, as described herein. While the various components are only illustrated in FIG. 11 as being connected with processing circuitry 1100, it will be understood that scheduling the system 14 may further include a bus for passing information between any combination of the various components of the scheduling system 14. The scheduling system 14 further may include programming or instructions configured to execute various operations described herein, such as those described above in relation to FIGS. 1-11.

The processing circuitry 1100 (and/or co-processor or any other processor assisting or otherwise associated therewith) may be in communication with the memory 1102 via a bus for passing information between components of the scheduling system 14. The processing circuitry 1100 may be embodied in a number of different ways and may, for example, include one or more processing devices configured to perform independently. The processing circuitry 1100 may include one or more processors configured in tandem via a bus to enable independent execution of software instructions, pipelining, and/or multithreading. The use of the term “processor” may be understood to include a single core processor, a multi-core processor, multiple processors of the scheduling system 14, remote or “cloud” processors, or any combination thereof.

The processing circuitry 1100 may be configured to execute software instructions stored in the memory 1102 or otherwise accessible to the processing circuitry 1100. In some embodiments, the processing circuitry 1100 may be configured to execute hard-coded functionality. Whether configured by hardware or software methods, or by a combination of hardware with software, the processing circuitry 1100 represents an entity or device (e.g., an element that can be physically embodied in circuitry) capable of performing operations according to various embodiments of the present disclosure while configured accordingly. Alternatively (or additionally), as another example, when the processing circuitry 1100 is embodied as an executor of software instructions, the software instructions may specifically configure the processing circuitry 1100 to perform the algorithms and/or operations described herein when the software instructions are executed.

The memory 1102 may be a non-transitory machine readable storage medium and may include, for example, one or more volatile and/or non-volatile memories. For example, the memory 1102 may be an electronic storage device (e.g., a computer readable storage medium). The memory 1102 may be configured to store information, data, content, applications, software instructions, or the like, for enabling the apparatus to operate or perform various functions in accordance with example embodiments contemplated herein.

The communications circuitry 1104 may include at least one device or circuitry embodied in either hardware or a combination of hardware and software that is configured to receive and/or transmit data from/to a network and/or any other device, circuitry, or module in communication with the scheduling system 14. The communications circuitry 1104 may include, for example, a network interface for enabling communications with a wired or wireless communication network. For example, the communications circuitry 1104 may include one or more network interface cards, antennas, buses, switches, routers, modems, and supporting hardware and/or software, or any other device suitable for enabling communications via a network. The communications circuitry 1104 may include the processing circuitry for causing transmission of such signals to a network or for handling receipt of signals received from a network.

The scheduling system 14 generally may include transportation route circuitry 1106 configured to determine and/or predict a route or logistical transportation schedule. The route or logistical transportation schedule may include one or more selections of transportation vehicles, a path or route, and/or other selections as noted herein. The transportation route circuitry 1106 may receive data (e.g., via the communication circuitry 1104) from one or more different sources (e.g., type of energy materials, quantity of energy material, etc.), one or more different vehicles 20 (e.g., type, contents, fuel amount, location, etc., for example as, described herein) and/or one or more delivery destinations 22, for example, as described herein, and/or related information. For example, upon reception of a delivery request (e.g., generated in response to the demand 46), the transportation route circuitry 1106 may generate a logistical transportation schedule 16 based on such data and the delivery request, as well as possibly other data described herein.

The transportation route circuitry 1106 may generate the logistical transportation schedule 16 via a machine learning model and/or a statistical or mathematical model, for example, as described herein. The model of models may be included in the modeling circuitry 1112. The transportation route circuitry 1106 may apply the data and the shipping request to the model or models in the modeling circuitry 1112, and the model or models may generate an output. The transportation route circuitry 1106 may concurrently or thereafter process such an output to generate a logistical transportation schedule 16 (e.g., format, aggregate, collate and/or otherwise process the output to generate a logistical transportation schedule 16). The scheduling system 14 may generate an effective and/or efficient (e.g., consuming less resources (e.g., fuel) and/or taking less time, among others, as will be understood by those skilled in the art) logistical transportation schedule. In some embodiments, the transportation route circuitry 1106 may, for example, in response to reception of one or more data sets (e.g., data for or relating to (a) energy material production data 34, (b) the available energy material data 36, (c) the vehicle data 40, and/or (d) the delivery destinations 22, as well as real-time data), determine a logistical transportation schedule 16 based at least in part on the one or more sets of data, the logistical transportation schedule 16 including (a) a selection of one or more of the vehicles 20, (b) a selection of one or more of the energy material production facilities 18, (c) a selection of one or more of the delivery destinations 22, and (d) a tailored transportation route 42 and/or an adjusted tailored transportation route 48.

In some embodiments, the scheduling system 14 may include simulation circuitry 1108 configured to simulate the generated logistical transportation schedule 16. The simulation circuitry 1108 may simulate the logistical transportation schedule 16 utilizing a number of scenarios, static and/or dynamic scenarios (e.g., adverse weather, other adverse conditions, routes blockages, fuel costs, among others, as will be understood by those skilled in the art). The simulation circuitry 1108 may output simulation results 64. The simulation circuitry 1108 may additionally determine an adjusted logistical transportation schedule, based at least in part on such simulations (e.g., the simulation results) and/or based on the logistical transportation schedule 16 (e.g., the logistical transportation schedule 16 determined by the transportation route circuitry 1106). The simulation circuitry 1108 may utilize one or more analytical models (e.g., a machine learning model) to generate the simulation results and/or the adjusted logistical schedule. The one or more analytical models may be included in the modeling circuitry 1112. Prior to simulation, selectable parameters (e.g., selectable by a user and/or a computing device) may be selected. Such selectable parameters may include one or more of weather, non-natural events, and/or other adverse and/or non-adverse conditions. The simulation results may include various probabilities that various events may occur (e.g., delays, cost increases, among others, as will be understood by those skilled in the art). The simulation circuitry 1108 may compare each of those probabilities against a corresponding threshold range and, if a probability is outside of such a threshold range, the simulation circuitry 1108 may determine an adjustment for the logistical transportation schedule 16. The simulation circuitry 1108 may update the logistical transportation schedule 16 based at least in part on the determined adjustments or may include, along the with the logistical transportation schedule 16, potential updates or options for the logistical transportation schedule 16.

The scheduling system 14 may include visualization circuitry 1110 configured to generate a user interface. The visualization circuitry 1110 may generate a user interface 52 (FIG. 9). The visualization circuitry 1110 may generate the user interface 52 on or for a user's computing device and/or a computing device associated with the scheduling system 14. The visualization circuitry 1110 may generate a map type visualization based on the logistical transportation schedule 16 and/or an adjusted logistical transportation schedule. The visualization circuitry 1110 may generate a list type view based on the logistical transportation schedule 16 and/or an adjusted logistical transportation schedule 16. A user may edit the logistical transportation schedule 16, accept the logistical transportation schedule 16, re-start the process, and/or initialize a delivery.

Several example methods according to embodiments of the disclosure are now described. The example methods are described as a collection of steps, which represent a sequence of operations. In the context of software, where applicable, the steps may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the method.

For example, a method for enhancing delivery of energy materials from one or more energy material production facilities, via a plurality of vehicles, to one or more delivery destinations, according to some embodiments, is now described. In some embodiments, the method may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The method also may include determining, via an analytical route model, a tailored transportation route for at least some of the plurality of vehicles based at least in part on: (a) the energy material production data, (b) the available energy material data, and (c) the vehicle data. In some embodiments, the method further may include simulating, via an analytical event simulation model, travel according to the tailored transportation route for each of the at least some of the plurality of vehicles, thereby to generate travel simulation results. The method also may include determining adjusted energy material production for the one or more energy material production facilities based at least in part on: (a) the travel simulation results, (b) the energy material production data, (c) the available energy material data, and (d) demand for the energy materials, the adjusted energy material production including an amount of energy material to produce by each of the at least some energy material production facilities. The method further may include determining an adjusted tailored transportation route based at least in part on: (a) the travel simulation results and (b) the adjusted energy material production. The adjusted tailored transportation route may include adjustment of the tailored transportation route for one or more of the at least some of the plurality of vehicles. The method also may include determining a logistical transportation schedule for each of the at least some of the plurality of vehicles, thereby to enhance the delivery of the energy materials from the one or more energy material production facilities, via the plurality of vehicles, to the one or more delivery destinations. In some embodiments, the logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination.

In some embodiments, the energy materials may include one or more of: hydrogen (e.g., green hydrogen produced by electrolyzers supplied with power from renewable energy sources, pink hydrogen produced by electrolyzer supplied with power by a nuclear energy source, gray hydrogen produced from natural gas via steam methane reforming with CO2 emissions released to the atmosphere, and blue hydrogen produced via natural gas via steam methane reforming with CO₂ captured), renewable feedstock, products from renewable feedstocks, hydrocarbon material, bio-mass, bio-fuel, bio-diesel, ethanol, synthetic fuel, renewable fuel, ethanol, hydrocarbon fuel, non-hydrocarbon fuel, petroleum-derived materials, petroleum feedstock, crude oil, tight oil, heavy crude oil, extra heavy crude oil, sand bitumen, light naphtha, gasoline, heavy naphtha, kerosene, diesel fuel, jet fuel, light gas oil, heating oil, light ends, heavy gas oil, lubricating oil, vacuum gas oil, residuum, paraffins, coke, asphalt, or precursors or derivatives thereof. Other types of materials are contemplated.

In some embodiments, the method further may include initiating travel according to the adjusted tailored transportation route for the one or more of the at least some of the plurality of vehicles, thereby to cause transport of the amount of energy materials produced by each of the at least some energy material production facilities to the delivery destination. In some embodiments, the method further may include initiating performance of the adjusted energy material production at one or more of the energy material production facilities to cause production of the amount of energy materials by each of the at least some energy material production facilities. In some embodiments, the one or more energy material production facilities may include one or more of: (a) one or more hydrogen production facilities, (b) one or more refineries, (c) one or more synthetic fuel production facilities, or (d) one of more renewable fuel production facilities. In some embodiments, the one or more storage facilities may include one or more tank farms. The one or more vehicles may include, for example, one or more barges, one or more tankers, one or more cargo ships, one or more boats, one or more bulk carriers, and/or one or more tow boat and barge combinations.

In some embodiments, the current weather associated with the one or more of the plurality of vehicles may include current weather associated with the tailored transportation route of the one or more of the plurality of vehicles. The predicted weather associated with the one or more of the plurality of vehicles may include future weather associated with the tailored transportation route of the one or more of the plurality of vehicles.

In some embodiments of the method, the travel delay associated with the one or more vehicles may include one or more of: (a) a travel delay due at least in part to a vehicle back-up at one or more locks along the tailored transportation route, (b) a travel delay due at least in part to a weather-related phenomenon along the tailored transportation route, (c) a travel delay due at least in part to a vehicle back-up along the tailored transportation route, (d) a lack of terminal availability for the vehicle for loading the energy material, (e) a lack of terminal availability for the vehicle for unloading the energy material at the delivery destination, or (f) the terminal availability for the vehicle 20 for unloading and loading the energy material at the delivery destination 22. The travel delay is a predicted travel delay based at least in part on one or more of real-time data or historical data.

In some embodiments of the method, the adjusted tailored transportation route further includes adjustment of the type of vehicle for at least one of the plurality of vehicles. In some embodiments, the adjusted energy material production may include a change in one or more of: (a) a change in an amount of energy material to produce at one or more of the plurality of energy material production facilities relative to a previously scheduled amount of energy material to be produced, (b) a change in a type of energy material to produce at one or more of the plurality of energy material production facilities relative to a previously scheduled type of energy material to be produced, or (c) a change in time for production of an energy material to produce at one or more of the plurality of energy material production facilities relative to a previously scheduled time for production of an energy material to produce.

In some embodiments of the method, determining the tailored transportation route may be based at least in part on one or more route tailoring factors. The one or more route tailoring factors may include one or more of: (a) minimized delivery time associated with delivery of one or more of the energy materials to the delivery destination; (b) minimized likelihood of shipping delay associated with delivery of one or more of the energy materials to the delivery destination due at least in part to one or more travel delays; (c) minimized shipping cost associated with delivery of one or more of the energy materials to the delivery destination; (d) maximized shipping efficiency associated with delivery of one or more of the energy materials to the delivery destination; or (e) minimized greenhouse gas emission associated with delivery of one or more of the energy materials to the delivery destination.

In some embodiments of the method, the vehicle data for each of the at least some of the plurality of vehicles further may include one or more of: (a) previously scheduled use of the vehicle, (b) capacity of the vehicle, (c) fuel type used by the vehicle, (d) current fuel level of the vehicle, (e) travel speed of the vehicle while at least partially loaded, (e) terminal availability for the vehicle for loading the energy material, (f) terminal availability for the vehicle for unloading the energy material at the delivery destination, or (g) the terminal availability for the vehicle 20 for unloading and loading the energy material at the delivery destination 22. In some embodiments, the vehicle data further may include a fuel usage rate for one or more of the plurality of vehicles.

In some embodiments, obtaining the energy material production data may include receiving the energy production material data from one or more energy material production controllers. The one or more of the energy material production controllers may be located at a respective energy material production facility. In some embodiments, obtaining the available energy material data may include receiving the available energy material data from one or more of: (a) one or more energy material production controllers or (b) one or more storage facilities. In some embodiments, obtaining the vehicle data may include receiving the vehicle data from one or more respective vehicles of the plurality of vehicles. In some embodiments, obtaining one or more of: (a) the energy material production data, (b) the available energy material data, (c) or the vehicle data, may include receiving one or more signals from one or more databases configured to store the one or more of (a) the energy material production data, (b) the available energy material data, (c) or the vehicle data.

In some embodiments of the method, the method further may include obtaining terminal data associated with one or more of: (a) one or more of loading terminals at which energy material is loaded onto one or more of the plurality of vehicles or (b) one or more unloading terminals at which energy material is unloaded from one or more of the plurality of vehicles. The terminal data may include one or more of: (a) a geographic location associated with a respective loading terminal, (b) a geographic location associated with a respective unloading terminal, (c) a demand at a respective unloading terminal associated with an energy material transported by one or more of the plurality of vehicles, (d) an amount of an energy material present at a respective unloading terminal associated with an energy material, (e) a number of berths at a respective loading terminal, (f) a number of berths at a respective unloading terminal, (g) a number of available berths at a respective loading terminal, or (h) a number of available berths at a respective unloading terminal. In some embodiments, one or more of the vehicle data or the terminal data may include one or more of: (a) an amount of time for loading energy material onto a respective one of the plurality of vehicles, or (b) an amount of time for unloading energy material from a respective one of the plurality of vehicles. In some embodiments of the method, (a) determining the tailored transportation route for the at least some of the plurality of vehicles may be based at least in part on the terminal data; (b) determining the adjusted energy material production may be based at least in part on the terminal data; (c) determining the adjusted tailored transportation route may be based at least in part on the terminal data; and/or (d) determining the logistical transportation schedule for each of the at least some of the plurality of vehicles may be based at least in part on the terminal data.

In some embodiments of the method, the method further may include obtaining one or more delivery biasing factors. The one or more delivery biasing factors may include one or more of: (a) a probability of availability of one or more of the energy materials; (b) a probability of availability of one or more of the plurality of vehicles; or (c) a probability of a travel delay associated with one or more of the plurality of vehicles. In some embodiments of the method, (a) determining the tailored transportation route for the at least some of the plurality of vehicles may be based at least in part on the one or more delivery biasing factors; (b) determining the adjusted energy material production may be based at least in part on the one or more delivery biasing factors; (c) determining the adjusted tailored transportation route may be based at least in part on the one or more delivery biasing factors; and/or (d) determining the logistical transportation schedule for each of the at least some of the plurality of vehicles may be based at least in part on the one or more delivery biasing factors.

In some embodiments of the method, one or more of the plurality of vehicles may include a tow boat and a plurality of barges towed by the tow boat. In at least some such embodiments, the vehicle data further may include, for the one or more of the plurality of vehicles, one or more of: (a) identification of the tow boat, (b) a number of the plurality of barges towed by the tow boat, (c) a maximum tow capacity of the tow boat, or (d) a maximum number of barges towable by the tow boat.

In some embodiments of the method, the method further may include displaying, via a display, an annotated map showing one or more of: (a) one or more of the plurality of vehicles, (b) the one or more of the energy material production facilities, (c) the one or more storage facilities, (d) the one or more delivery destinations, (e) the tailored transportation route of the at least some of the plurality of vehicles, or (f) the adjusted tailored transportation route of the at least some of the plurality of vehicles. In some embodiments, the displaying further may include displaying a simulation of one or more of the vehicles traveling according to one or more of (a) the tailored transportation route or (b) the adjusted tailored transportation route. Displaying the simulation may include dynamically displaying the simulation. In some embodiments of the method, the method may include displaying, via a display, one or more of: (a) the energy material production data, (b) the available energy material data, (c) or the vehicle data.

In some embodiments, a method for enhancing operation of one or more one or more energy material production facilities for producing energy materials, may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. The vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. In some embodiments, the method also may include determining, via an analytical route model, a tailored transportation route for at least some of the plurality of vehicles based at least in part on: (a) the energy material production data, (b) the available energy material data, and (c) the vehicle data. In some embodiments, the method further may include simulating, via an analytical event simulation model, travel according to the tailored transportation route for each of the at least some of the plurality of vehicles, thereby to generate travel simulation results. The method also may include determining adjusted energy material production for the one or more energy material production facilities based at least in part on: (a) the travel simulation results, (b) the energy material production data, (c) the available energy material data, and (d) demand for the energy materials. The adjusted energy material production may include an amount of energy material to produce by each of the at least some energy material production facilities. The method further may include determining an adjusted tailored transportation route based at least in part on: (a) the travel simulation results and (b) the adjusted energy material production. The adjusted tailored transportation route may include adjustment of the tailored transportation route for one or more of the at least some of the plurality of vehicles. The method also may include determining a logistical transportation schedule for each of the at least some of the plurality of vehicles, thereby to enhance operation of the one or more energy material production facilities. In some embodiments, the logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination. Some embodiments of the method may include one or more of the example operations previously described herein.

In some embodiments, a method for enhancing a logistical transportation schedule for delivery of energy materials from one or more energy material production facilities, via a plurality of vehicles, to one or more delivery destinations, may include obtaining (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities. The method further may include obtaining vehicle data for a plurality of vehicles. In some embodiments, the vehicle data may include one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles. The method also may include, in some embodiments, determining, via an analytical route model, a tailored transportation route for at least some of the plurality of vehicles based at least in part on: (a) the energy material production data, (b) the available energy material data, and (c) the vehicle data.

The method also may include determining adjusted energy material production for the one or more energy material production facilities based at least in part on: (a) the energy material production data, (b) the available energy material data, and (c) demand for the energy materials. The adjusted energy material production may include an amount of energy material to produce by each of the at least some energy material production facilities. The method further may include determining an adjusted tailored transportation route based at least in part on the adjusted energy material production. The adjusted tailored transportation route may include adjustment of the tailored transportation route for one or more of the at least some of the plurality of vehicles. The method also may include determining a logistical transportation schedule for each of the at least some of the plurality of vehicles, thereby to enhance the delivery of the energy materials from the one or more energy material production facilities, via the plurality of vehicles, to the one or more delivery destinations. In some embodiments, the logistical transportation schedule may identify one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination. Some embodiments of the method may include one or more of the example operations previously described herein.

It should be appreciated that at least some subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, mobile telephone devices, tablet computing devices, special-purposed hardware devices, network appliances, and the like.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/603,457, filed Nov. 28, 2023, titled “SYSTEMS, APPARATUSES, AND METHODS FOR ENHANCING DELIVERY OF ENERGY MATERIALS FROM ENERGY MATERIAL PRODUCTION FACILITIES TO DELIVERY DESTINATIONS,” the disclosure of which is incorporated herein by reference in its entirety.

Furthermore, the scope of the present disclosure shall be construed to cover various modifications, combinations, additions, alterations, among others, as will be understood by those skilled in the art, above and to the above-described embodiments, which shall be considered to be within the scope of this disclosure. Accordingly, various features and characteristics as discussed herein may be selectively interchanged and applied to other illustrated and non-illustrated embodiments, and numerous variations, modifications, and additions further may be made thereto without departing from the spirit and scope of the present disclosure as set forth in the appended claims.

1. A method for enhancing delivery of energy materials from one or more energy material production facilities, via a plurality of vehicles, to one or more delivery destinations, the method comprising:
obtaining, in real-time and via a controller from one or more of (i) one or more energy material production controllers positioned at a respective energy material production facility or (ii) sensors positioned at one or more storage facilities, (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities;
obtaining, in real-time and via the controller from one or more vehicle controllers and one or more sensors positioned on a respective vehicle, vehicle data for a plurality of vehicles, the vehicle data including one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles;
determining, via an analytical route model of the controller, a tailored transportation route for at least some of the plurality of vehicles based at least in part on: (a) the energy material production data, (b) the available energy material data, and (c) the vehicle data;
simulating, via an analytical event simulation model of the controller, travel according to the tailored transportation route for each of the at least some of the plurality of vehicles, thereby to generate travel simulation results;
automatically determining, via the controller, an adjusted tailored transportation route based on part on the travel simulation results, the adjusted tailored transportation route including adjustment of the tailored transportation route for one or more of the at least some of the plurality of vehicles;
automatically determining, via the controller, a logistical transportation schedule for each of the at least some of the plurality of vehicles based on the adjusted tailored transportation route, thereby to enhance the delivery of the energy materials from the one or more energy material production facilities, via the plurality of vehicles, to the one or more delivery destinations, the logistical transportation schedule identifying one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, or (f) a transportation route for the vehicle from the storage facility to the delivery destination;
determining, via the controller, adjusted energy material production for the one or more energy material production facilities based on: (a) energy material output capable by the one or more energy material production facilities, (b) a type of energy material able to be produced by the one or more energy material production facilities, (c) the energy material production data, (d) the available energy material data, and (e) the demand for the energy materials, the adjusted energy material production including an amount of energy material to produce by each of the at least some energy material production facilities;
determining, via the controller, the adjusted tailored transportation route based at least in part on the adjusted energy material production; and
operating the one or more energy material production facilities based on the adjusted energy material production.

2. The method of claim 1, further comprising initiating, via the controller, communications of travel data according to the adjusted tailored transportation route for the one or more of the at least some of the plurality of vehicles, thereby to cause transport of the amount of energy materials produced by each of the at least some energy material production facilities to the delivery destination, and wherein the adjusted tailored transportation route further includes adjustment of the type of vehicle for at least one of the plurality of vehicles.

3. (canceled)

4. The method of claim 1, further comprising initiating communications of performance data of the adjusted energy material production at one or more of the energy material production facilities, thereby to cause production of the amount of energy materials by each of the at least some energy material production facilities.

5. The method of claim 1, wherein the energy materials comprise one or more of: hydrogen, renewable feedstock, hydrocarbon material, bio-mass, bio-fuel, bio-diesel, ethanol, synthetic fuel, renewable fuel, hydrocarbon fuel, non-hydrocarbon fuel, petroleum-derived materials, petroleum feedstock, crude oil, tight oil, heavy crude oil, extra heavy crude oil, sand bitumen, light naphtha, gasoline, heavy naphtha, kerosene, diesel fuel, jet fuel, light gas oil, heating oil, light ends, heavy gas oil, lubricating oil, vacuum gas oil, residuum, paraffins, coke, asphalt, or derivatives thereof, and wherein one or more of (a) the analytical route model or (b) the analytical event simulation model includes a machine-learning trained analytical model.

6. The method of claim 1, wherein the one or more energy material production facilities comprise one or more of: (a) one or more hydrogen production facilities, (b) one or more refineries, (c) one or more synthetic fuel production facilities, or (d) one of more renewable fuel production facilities, and wherein the one or more vehicles comprise one or more of: one or more waterway vehicles, one or more barges, one or more tankers, one or more cargo ships, one or more boats, one or more bulk carriers, one or more tow boat and barge combinations, one or more rail cars, or one or more tanker trucks.

7. The method of claim 1, wherein the one or more storage facilities comprises one or more tank farms.

8. The method of claim 1, wherein:
the current weather associated with the one or more of the plurality of vehicles comprises current weather associated with the tailored transportation route of the one or more of the plurality of vehicles, wherein the predicted weather associated with the one or more of the plurality of vehicles comprises future weather associated with the tailored transportation route of the one or more of the plurality of vehicles, wherein the travel delay associated with the one or more vehicles comprises one or more of: (a) a travel delay due at least in part to a vehicle back-up at one or more locks along the tailored transportation route, (b) a travel delay due at least in part to a weather-related phenomenon along the tailored transportation route, (c) a travel delay due at least in part to a vehicle back-up along the tailored transportation route, (d) a lack of terminal availability for the vehicle for loading the energy material, or (e) a lack of terminal availability for the vehicle for unloading the energy material at the delivery destination, and wherein the travel delay is a predicted travel delay based at least in part on one or more of real-time data or historical data.

9. The method of claim 1, wherein the adjusted energy material production comprises a change in one or more of: (a) a change in an amount of energy material to produce at one or more of the plurality of energy material production facilities relative to a previously scheduled amount of energy material to be produced, (b) a change in a type of energy material to produce at one or more of the plurality of energy material production facilities relative to a previously scheduled type of energy material to be produced, or (c) a change in time for production of an energy material to produce at one or more of the plurality of energy material production facilities relative to a previously scheduled time for production of an energy material to produce.

10. The method of claim 1, wherein determining the tailored transportation route is based at least in part on one or more route tailoring factors, the one or more route tailoring factors comprising one or more of:
(a) minimized delivery time associated with delivery of one or more of the energy materials to the delivery destination;
(b) minimized likelihood of shipping delay associated with delivery of one or more of the energy materials to the delivery destination due at least in part to one or more travel delays;
(c) minimized shipping cost associated with delivery of one or more of the energy materials to the delivery destination;
(d) maximized shipping efficiency associated with delivery of one or more of the energy materials to the delivery destination; or (e) minimized greenhouse gas emission associated with delivery of one or more of the energy materials to the delivery destination.

11. The method of claim 1, wherein the vehicle data for each of the at least some of the plurality of vehicles further comprises one or more of: (a) previously scheduled use of the vehicle, (b) capacity of the vehicle, (c) fuel type used by the vehicle, (d) current fuel level of the vehicle, (e) travel speed of the vehicle while at least partially loaded, (e) terminal availability for the vehicle for loading the energy material, or (f) terminal availability for the vehicle for unloading the energy material at the delivery destination.

12. (canceled)

13. The method of claim 1, further comprising obtaining terminal data associated with one or more of: (a) one or more of loading terminals at which energy material is loaded onto one or more of the plurality of vehicles or (b) one or more unloading terminals at which energy material is unloaded from one or more of the plurality of vehicles, and wherein one or more of:
(a) determining the tailored transportation route for the at least some of the plurality of vehicles is based at least in part on the terminal data,
(b) determining the adjusted tailored transportation route is based at least in part on the terminal data, or
(c) determining the logistical transportation schedule for each of the at least some of the plurality of vehicles is based at least in part on the terminal data.

14. The method of claim 13, wherein the terminal data comprises one or more of: (a) a geographic location associated with a respective loading terminal, (b) a geographic location associated with a respective unloading terminal, (c) a demand at a respective unloading terminal associated with an energy material transported by one or more of the plurality of vehicles, (d) an amount of an energy material present at a respective unloading terminal associated with an energy material, (e) a number of berths at a respective loading terminal, (f) a number of berths at a respective unloading terminal, (g) a number of available berths at a respective loading terminal, or (h) a number of available berths at a respective unloading terminal.

15. The method of claim 13, wherein one or more of the vehicle data or the terminal data comprises one or more of: (a) an amount of time for loading energy material onto a respective one of the plurality of vehicles, or (b) an amount of time for unloading energy material from a respective one of the plurality of vehicles.

16. The method of claim 1, further comprising:
obtaining one or more delivery biasing factors; and
one or more of: (a) determining the tailored transportation route for the at least some of the plurality of vehicles is based at least in part on the one or more delivery biasing factors, (b) determining the adjusted tailored transportation route is based at least in part on the one or more delivery biasing factors, or (c) determining the logistical transportation schedule for each of the at least some of the plurality of vehicles is based at least in part on the one or more delivery biasing factors, and
wherein the one or more delivery biasing factors comprise one or more of (a) a probability of availability of one or more of the energy materials, (b) a probability of availability of one or more of the plurality of vehicles, or (c) a probability of a travel delay associated with one or more of the plurality of vehicles.

17. The method of claim 1, wherein obtaining one or more of: (a) the energy material production data, (b) the available energy material data, (c) or the vehicle data, comprises receiving one or more signals from one or more databases configured to store the one or more of (a) the energy material production data, (b) the available energy material data, (c) or the vehicle data.

18. The method of claim 1, wherein one or more of the plurality of vehicles comprises a tow boat and a plurality of barges towed by the tow boat, wherein the vehicle data further includes, for the one or more of the plurality of vehicles, one or more of: (a) identification of the tow boat, (b) a number of the plurality of barges towed by the tow boat, (c) a maximum tow capacity of the tow boat, or (d) a maximum number of barges towable by the tow boat, and wherein the vehicle data further comprises a fuel usage rate for one or more of the plurality of vehicles.

19. The method of claim 1, further comprising displaying, via a display, an annotated map showing one or more of: (a) one or more of the plurality of vehicles, (b) the one or more of the energy material production facilities, (c) the one or more storage facilities, (d) the one or more delivery destinations, (e) the tailored transportation route of the at least some of the plurality of vehicles, or (f) the adjusted tailored transportation route of the at least some of the plurality of vehicles, wherein the displaying further comprises displaying a simulation of one or more of the vehicles traveling according to one or more of (a) the tailored transportation route or (b) the adjusted tailored transportation route, and wherein displaying the simulation comprises dynamically displaying the simulation.

20. A scheduling system for enhancing generation of a logistical transportation schedule for delivery of energy materials from one or more energy material production facilities, via a plurality of vehicles, to one or more delivery destinations, the scheduling system comprising:
one or more first sensors positioned on each of the plurality of vehicles to provide vehicle data;
one or more second sensors positioned at each of the one or more energy material production facilities to provide energy production data and available energy material data; and
a logistics controller in communication with one or more of: (a) one or more of the plurality of vehicles, (b) the one or more first sensors, (c) one or more of the energy material production facilities, (d) the one or more second sensors, or (e) one or more of the delivery destinations, the logistics controller configured to:
obtain (a) energy material production data, based at least in part on output of energy materials from the one or more energy material production facilities, and (b) available energy material data, based at least in part on energy materials stored at one or more of: (1) one or more of the one or more energy material production facilities or (2) one or more storage facilities;
obtain vehicle data for a plurality of vehicles, the vehicle data including one or more of: (a) identification of the plurality of vehicles, (b) a current location of one or more of the plurality of vehicles, (c) type of energy material carried by one or more of the plurality of vehicles, (d) amount of energy material carried by one or more of the plurality of vehicles, (e) type of vehicle for one or more of the plurality of vehicles, (f) current weather associated with one or more of the plurality of vehicles, (g) predicted weather associated with one or more of the plurality of vehicles, (h) a travel delay associated with one or more of the plurality of vehicles, or (i) delivery destination for one or more of the plurality of vehicles;
determine, via an analytical route model, a tailored transportation route for at least some of the plurality of vehicles based at least in part on: (a) the energy material production data, (b) the available energy material data, and (c) the vehicle data;
determine adjusted energy material production for the one or more energy material production facilities based at least in part on: (a) energy material output capable by the one or more energy material production facilities, (b) a type of energy material able to be produced by the one or more energy material production facilities, (c) the available energy material data, and (d) demand for the energy materials, the adjusted energy material production including an amount of energy material to produce by each of the at least some energy material production facilities;
determine an adjusted tailored transportation route based at least in part on the adjusted energy material production, the adjusted tailored transportation route including adjustment of the tailored transportation route for one or more of the at least some of the plurality of vehicles;
determine a logistical transportation schedule for each of the at least some of the plurality of vehicles, thereby to enhance the delivery of the energy materials from the one or more energy material production facilities, via the plurality of vehicles, to the one or more delivery destinations, the logistical transportation schedule identifying one or more of: (a) a vehicle, (b) an energy material production facility supplying energy material to the vehicle, (c) a storage facility supplying energy material to the vehicle, (d) a delivery destination for the vehicle, (e) a tailored transportation route for the vehicle from the energy material production facility to the delivery destination, (f) or a transportation route for the vehicle from the storage facility to the delivery destination;
initiate operation of the one or more energy material production facilities based on the adjusted energy material production.

21. The scheduling system of claim 20, wherein the logistics controller further is configured to:
simulate, via an analytical event simulation model, travel according to the tailored transportation route for each of the at least some of the plurality of vehicles, thereby to generate travel simulation results, and
determine one or more of (a) the adjusted energy material production or (b) the adjusted tailored transportation route, based at least in part on the travel simulation results.

22. The scheduling system of claim 21, wherein the logistics controller further is configured to initiate travel according to the adjusted tailored transportation route for the one or more of the at least some of the plurality of vehicles, thereby to cause transport of the amount of energy materials produced by each of the at least some energy material production facilities to the delivery destination.

23. (canceled)

24. The scheduling system of claim 20, wherein the energy materials comprise one or more of: hydrogen, renewable feedstock, products from renewable feedstocks, hydrocarbon material, bio-mass, bio-fuel, bio-diesel, ethanol, synthetic fuel, renewable fuel, ethanol, hydrocarbon fuel, non-hydrocarbon fuel, petroleum-derived materials, petroleum feedstock, crude oil, tight oil, heavy crude oil, extra heavy crude oil, sand bitumen, light naphtha, gasoline, heavy naphtha, kerosene, diesel fuel, jet fuel, light gas oil, heating oil, light ends, heavy gas oil, lubricating oil, vacuum gas oil, residuum, paraffins, coke, asphalt, or derivatives thereof, wherein the one or more energy material production facilities comprise one or more of: (a) one or more hydrogen production facilities, (b) one or more refineries, (c) one or more synthetic fuel production facilities, or (d) one of more renewable fuel production facilities, and wherein the one or more vehicles comprise one or more of: one or more barges, one or more tankers, one or more cargo ships, one or more boats, one or more bulk carriers, or one or more tow boat and barge combinations.

25. The scheduling system of claim 23, wherein the current weather associated with the one or more of the plurality of vehicles comprises current weather associated with the tailored transportation route of the one or more of the plurality of vehicles, wherein the predicted weather associated with the one or more of the plurality of vehicles comprises future weather associated with the tailored transportation route of the one or more of the plurality of vehicles, wherein the travel delay associated with the one or more vehicles comprises one or more of: (a) a travel delay due at least in part to a vehicle back-up at one or more locks along the tailored transportation route, (b) a travel delay due at least in part to a weather-related phenomenon along the tailored transportation route, (c) a travel delay due at least in part to a vehicle back-up along the tailored transportation route, (d) a lack of terminal availability for the vehicle for loading the energy material, or (e) a lack of terminal availability for the vehicle for unloading the energy material at the delivery destination, wherein the travel delay is a predicted travel delay based at least in part on one or more of real-time data or historical data, and wherein the analytical route model includes a machine learning analytical model.

26. The scheduling system of claim 23, wherein the logistics controller further is configured to determine the adjusted tailored transportation route based at least in part on one or more route tailoring factors, the one or more route tailoring factors comprising one or more of:
(a) minimized delivery time associated with delivery of one or more of the energy materials to the delivery destination;
(b) minimized likelihood of shipping delay associated with delivery of one or more of the energy materials to the delivery destination due at least in part to one or more travel delays;
(c) minimized shipping cost associated with delivery of one or more of the energy materials to the delivery destination;
(d) maximized shipping efficiency associated with delivery of one or more of the energy materials to the delivery destination; or
(e) minimized greenhouse gas emission associated with delivery of one or more of the energy materials to the delivery destination.

27. The scheduling system of claim 23, wherein the logistics controller further is configured to receive the available energy material data from one or more of: (a) one or more energy material production controllers or (b) one or more storage facilities, wherein the one or more of the energy material production controllers is located at a respective energy material production facility, wherein the logistics controller further is configured to receive the vehicle data from one or more respective vehicles of the plurality of vehicles, and wherein the logistics controller further is configured to obtain terminal data associated with one or more of: (a) one or more of loading terminals at which energy material is loaded onto one or more of the plurality of vehicles or (b) one or more unloading terminals at which energy material is unloaded from one or more of the plurality of vehicles.

28. The scheduling system of claim 27, wherein the terminal data comprises one or more of: (a) a geographic location associated with a respective loading terminal, (b) a geographic location associated with a respective unloading terminal, (c) a demand at a respective unloading terminal associated with an energy material transported by one or more of the plurality of vehicles, (d) an amount of an energy material present at a respective unloading terminal associated with an energy material, (e) a number of berths at a respective loading terminal, (f) a number of berths at a respective unloading terminal, (g) a number of available berths at a respective loading terminal, or (h) a number of available berths at a respective unloading terminal, wherein one or more of the vehicle data or the terminal data comprises one or more of: (a) an amount of time for loading energy material onto a respective one of the plurality of vehicles, or (b) an amount of time for unloading energy material from a respective one of the plurality of vehicles, wherein the logistics controller further is configured to one or more of (a) determine the tailored transportation route for the at least some of the plurality of vehicles based at least in part on the terminal data, (b) determine the adjusted energy material production based at least in part on the terminal data, (c) determine the adjusted tailored transportation route based at least in part on the terminal data, or (d) determine the logistical transportation schedule for each of the at least some of the plurality of vehicles based at least in part on the terminal data, and wherein the logistics controller further is configured to:
obtain one or more delivery biasing factors; and
one or more of:
(a) determine the tailored transportation route for the at least some of the plurality of vehicles based at least in part on the one or more delivery biasing factors;
(b) determine the adjusted energy material production based at least in part on the one or more delivery biasing factors;
(c) determine the adjusted tailored transportation route based at least in part on the one or more delivery biasing factors; or
(d) determine the logistical transportation schedule for each of the at least some of the plurality of vehicles based at least in part on the one or more delivery biasing factors, the one or more delivery biasing factors comprises one or more of:
(a) a probability of availability of one or more of the energy materials;
(b) a probability of availability of one or more of the plurality of vehicles; or
(c) a probability of a travel delay associated with one or more of the plurality of vehicles.

29. The scheduling system of claim 26, wherein the vehicle data for each of the at least some of the plurality of vehicles further comprises one or more of: (a) previously scheduled use of the vehicle, (b) capacity of the vehicle, (c) fuel type used by the vehicle, (d) current fuel level of the vehicle, (e) travel speed of the vehicle while at least partially loaded, (e) terminal availability for the vehicle for loading the energy material, or (f) terminal availability for the vehicle for unloading the energy material at the delivery destination, and wherein the logistics controller further is configured to receive one or more signals from one or more databases configured to store the one or more of (a) the energy material production data, (b) the available energy material data, (c) or the vehicle data, wherein one or more of the plurality of vehicles comprises a tow boat and a plurality of barges towed by the tow boat, wherein the vehicle data further includes, for the one or more of the plurality of vehicles, one or more of: (a) identification of the tow boat, (b) a number of the plurality of barges towed by the tow boat, (c) a maximum tow capacity of the tow boat, or (d) a maximum number of barges towable by the tow boat, wherein the vehicle data further comprises a fuel usage rate for one or more of the plurality of vehicles, wherein the logistics controller further is configured to display, via a display device, an annotated map showing one or more of: (a) one or more of the plurality of vehicles, (b) the one or more of the energy material production facilities, (c) the one or more storage facilities, (d) the one or more delivery destinations, (e) the tailored transportation route of the at least some of the plurality of vehicles, or (f) the adjusted tailored transportation route of the at least some of the plurality of vehicles, wherein the logistics controller further is configured to display a simulation of one or more of the vehicles traveling according to one or more of (a) the tailored transportation route or (b) the adjusted tailored transportation route, wherein the logistics controller is further configured to display, via a display device, one or more of: (a) the energy material production data, (b) the available energy material data, (c) or the vehicle data, and wherein the logistics controller further is configured to simulate, via an analytical event simulation model, travel according to the tailored transportation route for each of the at least some of the plurality of vehicles, thereby to generate travel simulation results the analytical event simulation model including a machine learning analytical model.
